(19) United States
(12) Patent Application Publication
(10) Pub. No.: US 2023/0259365 A1
(43) Pub. Date: Aug. 17, 2023

(54) COMPUTER-READABLE RECORDING MEDIUM STORING CONVERSION PROGRAM AND CONVERSION METHOD

(71) Applicant: Fujitsu Limited, Kawasaki-shi (JP)

(72) Inventors: Masashi Hayano, Shinjuku (JP); Takumi Honda, Kawasaki (JP)

(73) Assignee: Fujitsu Limited, Kawasaki-shi (JP)

(21) Appl. No.: 17/983,432

(22) Filed: Nov. 9, 2022

(30) Foreign Application Priority Data
Feb. 17, 2022 (JP) 2022-023009

(51) Int. Cl. G06F 9/30

(52) U.S. Cl. CPC G06F 9/30192; G06F 9/30101

(57) ABSTRACT

A recording medium stores a program for causing a computer to execute process including: incrementing a counter when a CISC instruction is converted into a RISC instruction; updating conversion timing of a register used for conversion with a value of the counter; recording a difference before and after update of conversion timing as an interval; selecting a register number from among register numbers that have a same interval condition, and updating the use register number with a selected register number; saving data for a register indicated by the updated use register number and generating an instruction for reading data of a memory operand; when a CISC instruction before conversion does not include the use register number, generating an instruction for reading data of a memory operand without restoring and saving data for a register indicated by the use register number; and generating the RISC instruction equivalent to the CISC instruction.

### CROSS-REFERENCE TO RELATED APPLICATION

This application is based upon and claims the benefit of priority of the prior Japanese Patent Application No. 2022-23009, filed on Feb. 17, 2022, the entire contents of which are incorporated herein by reference.

### FIELD

The embodiments discussed herein are related to a computer-readable recording medium storing a machine language conversion program and the like.

### BACKGROUND

A library of deep learning optimizes a function at the time of execution and achieves high-speed processing. Since a function serving as a core that largely affects processing performance is developed by an assembly code, it has to be adapted to each architecture. To reduce the cost of developing a function serving as a core, there is a translator for converting an instruction for one architecture into that for another architecture. By using this translator, an instruction developed for an architecture of a complex instruction set computer (CISC) may be converted into an instruction for an architecture of a reduced instruction set computer (RISC).

Japanese Laid-open Patent Publication No. 2012-226486 and U.S. Patent Application Publication No. 2020/0117454 are disclosed as related art.

### SUMMARY

According to an aspect of the embodiments, A non-transitory computer-readable recording medium stores a conversion program for causing a computer to execute a process including: incrementing a counter each time a complex instruction set computer (CISC) instruction is converted into a reduced instruction set computer (RISC) instruction; when a CISC instruction with a memory operand is converted into a RISC instruction, updating conversion timing of a register used for conversion with a value of the counter; recording a difference before and after update of conversion timing as an interval; when a CISC instruction before conversion includes a use register number that stores a register number to be used for conversion of a memory operand, restoring data for a register indicated by the use register number, using a register management table in which a register number, conversion timing, and an interval are associated with each other and randomly selecting a register number from among register numbers that have a same interval condition, and updating the use register number with a selected register number; saving data for a register indicated by the updated use register number, and using a register indicated by the updated use register number and generating an instruction for reading data of a memory operand; when a CISC instruction before conversion does not include the use register number, using a register indicated by the use register number and generating an instruction for reading data of a memory operand without restoring and saving data for a register indicated by the use register number; and generating the RISC instruction equivalent to the CISC instruction.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a functional configuration of an information processing apparatus according to Embodiment 1,

FIG. 2 is a diagram illustrating an example of a register management table according to Embodiment 1;

FIG. 3 is a diagram illustrating an example of a reference idx according to Embodiment 1;

FIG. 4 is a diagram illustrating an example of a counter according to Embodiment 1;

FIG. 5A is a diagram (1) illustrating an example of conversion processing according to Embodiment 1;

FIG. 5B is a diagram (2) illustrating an example of the conversion processing according to Embodiment 1;

FIG. 5C is a diagram (3) illustrating an example of the conversion processing according to Embodiment 1;

FIG. 5D is a diagram (4) illustrating an example of the conversion processing according to Embodiment 1;

FIG. 5E is a diagram (5) illustrating an example of the conversion processing according to Embodiment 1;

FIG. 5F is a diagram (6) illustrating an example of the conversion processing according to Embodiment 1;

FIG. 6A is a diagram (1) illustrating another example of the conversion processing according to Embodiment 1;

FIG. 6B is a diagram (2) illustrating another example of the conversion processing according to Embodiment 1;

FIG. 6C is a diagram (3) illustrating another example of the conversion processing according to Embodiment 1;

FIG. 6D is a diagram (4) illustrating another example of the conversion processing according to Embodiment 1;

FIG. 6E is a diagram (5) illustrating another example of the conversion processing according to Embodiment 1;

FIGS. 7A and 7B are a diagram illustrating an example of a flowchart of the conversion processing according to Embodiment 1;

FIG. 8 is a diagram illustrating a problem of the conversion processing according to Embodiment 1;

FIG. 9 is a block diagram illustrating an example of a functional configuration of an information processing apparatus according to Embodiment 2;

FIG. 10 is a diagram illustrating an example of a register management table according to Embodiment 2;

FIG. 11A is a diagram (1) describing recording of intervals;

FIG. 11B is a diagram (2) describing recording of intervals;

FIG. 12 is a diagram describing register selection according to Embodiment 2;

FIGS. 13A and 13B are a diagram illustrating an example of a flowchart of conversion processing according to Embodiment 2;

FIG. 14 is a diagram illustrating an example of a flowchart of register selection processing according to Embodiment 2;

FIG. 15 is a diagram describing an effect of the conversion processing according to Embodiment 2;

FIG. 16A is a diagram (1) describing a pattern in which the efficiency decreases;

FIG. 16B is a diagram (2) describing a pattern in which the efficiency decreases;

FIG. 16C is a diagram (3) describing a pattern in which the efficiency decreases;

FIG. 17 is a block diagram illustrating an example of a functional configuration of an information processing apparatus according to Embodiment 3;

FIGS. 18A and 18B are a diagram illustrating an example of a flowchart of register selection processing according to Embodiment 3;

FIG. 19A is a diagram (1) illustrating an example of the register selection processing according to Embodiment 3;

FIG. 19B is a diagram (2) illustrating an example of the register selection processing according to Embodiment 3;

FIG. 19C is a diagram (3) illustrating an example of the register selection processing according to Embodiment 3;

FIG. 19D is a diagram (4) illustrating an example of the register selection processing according to Embodiment 3;

FIG. 19E is a diagram (5) illustrating an example of the register selection processing according to Embodiment 3;

FIG. 20A is a diagram (1) illustrating another example of the register selection processing according to Embodiment 3;

FIG. 20B is a diagram (2) illustrating another example of the register selection processing according to Embodiment 3;

FIG. 21 is a diagram describing an example of a hardware configuration; and

FIG. 22 is a reference diagram for conversion of a CISC instruction with a memory operand into a RISC instruction.

### DESCRIPTION OF EMBODIMENTS

RISC is a method employed in ARM (registered trademark) central processing units (CPUs). A RISC instruction is an instruction in which a register is an operand on the assumption that data exists in the register. “fmla zreg0, zreg, zreg2;” is an example of an assembly code. This instruction represents a multiply-add instruction “zreg0←zreg0+zreg1×zreg2” of 512 bits. For example, this instruction represents that the values of vector registers zreg1 and zreg2 of 512 bits are multiplied, the multiplication result is added to the value of zreg0, and the result is stored in zreg0.

By contrast, CISC is a method employed in Intel (registered trademark) CPUs. A CISC instruction as a single instruction may designate a register and a memory address as operands. “vfmadd231ps zmm0, zmm1, ptr[r10];” is an example of an assembly code. This instruction represents a multiply-add instruction “zmm0←zmm0+zmm1×ptr[r10]” of 512 bits. For example, this instruction represents that 512 bits are read by performing memory access using the value of register r10 of 512 bits as an address, the read value is multiplied by the value of vector register zmm1 of 512 bits, the multiplication result is added to the value of vector register zmm0, and the result is stored in zmm0.

However, there is a problem in which the execution performance is degraded when an assembly code written with a CISC instruction with a memory operand is converted into a RISC instruction. For example, when an assembly code written with a CISC instruction with a memory operand is converted into a RISC instruction, an additional register has to be used temporarily. To secure a register, a store instruction and a load instruction are generated for saving the data stored in the register and restoring the data to the register. An increase in the number of such store and load instructions causes a decrease in processing speed, and the execution performance is degraded.

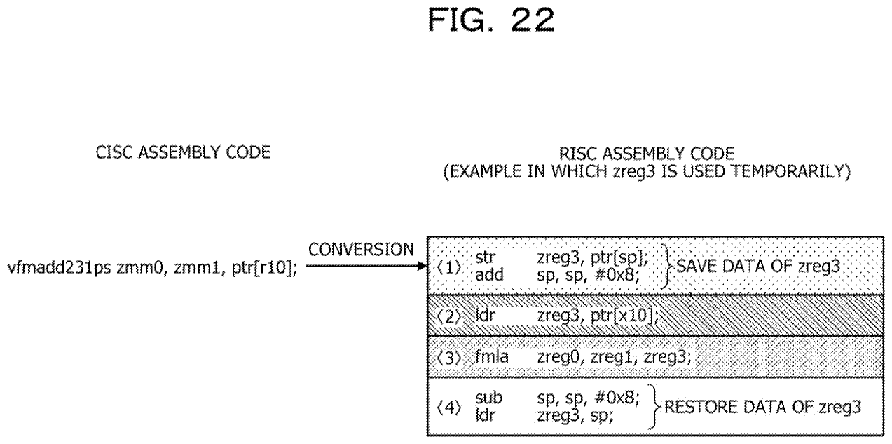

Conversion of a CISC instruction with a memory operand into a RISC instruction will be described. FIG. 22 is a reference diagram for conversion of a CISC instruction with a memory operand into a RISC instruction. As illustrated in FIG. 22, when a CISC assembly code is “vfmadd231ps zmm0, zmm1, ptr[r10];”, the corresponding RISC assembly code is a sequence of instructions of <1> to <4> illustrated on the right side. <1> To save data, use a store (str) instruction and write data of a specific register zreg3 to be used temporarily to a memory (sp). <2> Use a load (Idr) instruction and read data ptr[x10] serving as a memory operand into the specific register zreg3. <3> Execute a RISC instruction equivalent to the instruction before conversion. <4> To restore the data of the specific register zreg3, use a load (Idr) instruction and read the data saved to sp into zreg3.

For example, when a plurality of CISC instructions with a memory operand is sequentially converted into RISC instructions, the store and load instructions of (1) and (4) are generated for saving and restoring data each time conversion is performed, and thus the execution performance is degraded.

According to one aspect, an object is to improve the execution performance when an assembly code written in a CISC instruction with a memory operand is converted into a RISC instruction.

Hereinafter, the embodiments of a conversion program and a conversion method according to the present disclosure will be described in detail with reference to the drawings. This disclosure is not limited by the embodiments. The embodiments may be combined with each other as appropriate within the scope without any contradiction.

### Embodiment 1

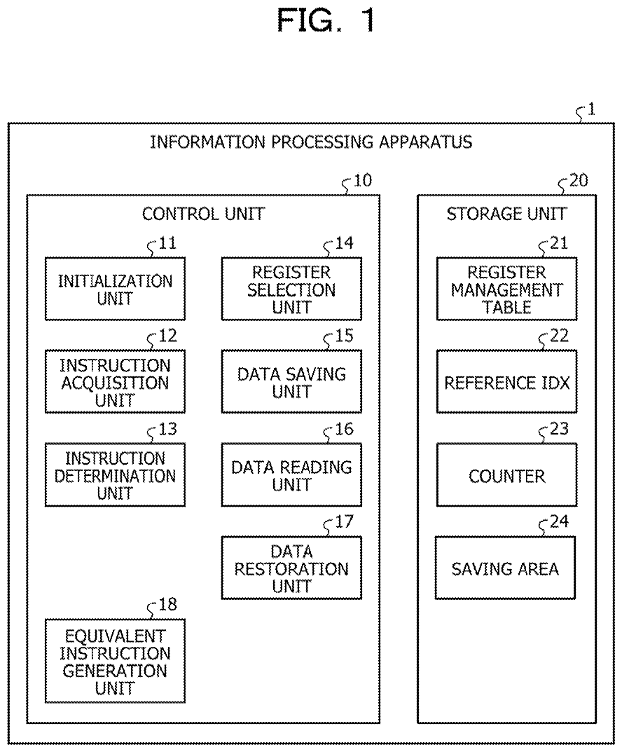

FIG. 1 is a block diagram illustrating an example of a functional configuration of an information processing apparatus according to an embodiment. An information processing apparatus 1 sequentially converts a plurality of complex instruction set computer (CISC) instructions with memory operands into reduced instruction set computer (RISC) instructions. When performing conversion, if the register used for reading the data of the memory operand in the previous conversion is not used in the instruction in the current conversion, the information processing apparatus 1 uses the register without restoring and saving data for the register. In the embodiment, a register to be used for conversion is a vector register. However, this is an example and the embodiment is not limited to this.

The information processing apparatus 1 includes a control unit 10 and a storage unit 20. The control unit 10 is a processing unit that controls the entire information processing apparatus 1, and includes an initialization unit 11, an instruction acquisition unit 12, an instruction determination unit 13, a register selection unit 14, a data saving unit 15, a data reading unit 16, a data restoration unit 17, and an equivalent instruction generation unit 18. The storage unit 20 includes a register management table 21, a reference idx 22, a counter 23, and a saving area 24.

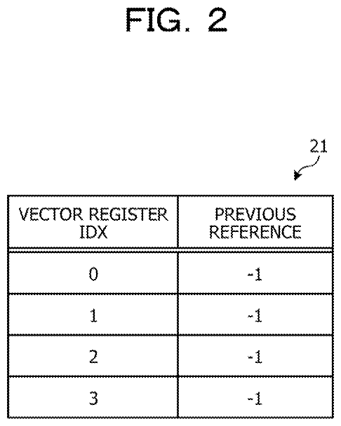

The register management table 21 is a management table in which a vector register idx and the timing at which the register indicating the vector register idx was previously referred to (used) are associated with each other. An example of the register management table 21 will be described with reference to FIG. 2. FIG. 2 is a diagram illustrating an example of the register management table according to the embodiment. As illustrated in FIG. 2, the register management table 21 is information in which a vector register idx and previous reference are associated with each other. A vector register idx is an index for uniquely identifying a vector register. The index may be a number. Previous reference indicates the timing at which a register was previously referred to (used). The value of previous reference corresponds to the value of the counter 23 to be described later. As an example, “−1” is an initial value and indicates non-use.

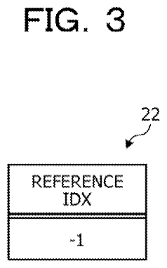

Returning to FIG. 1, the reference idx 22 indicates a vector register idx to be additionally used at the time of conversion of an instruction with a memory operand. In CISC, a plurality of kinds of processing may be performed with a single instruction, and not only a register but also a memory address may be designated as an operand. For example, in an assembly code for calculating “zmm0←zmm0+zmm1× ptr[r10]”, memory access is performed using the value of register r10 as an address, the value obtained by the memory access is multiplied by the value of register zmm1, the value of vector register zmm0 is added, and the result is stored in the vector register zmm0. For example, the operand of an instruction is not limited to a register. By contrast, in RISC, the operand of an instruction is limited to a register. Accordingly, when a CISC instruction with a memory operand is converted into a RISC instruction, there has to be an additional register to be used for conversion of the memory operand. The vector register idx of this register is stored in the reference idx 22. An example of the reference idx 22 will be described with reference to FIG. 3.

FIG. 3 is a diagram illustrating an example of the reference idx according to the embodiment. As illustrated in FIG. 3, the reference idx 22 is an idx of a vector register to be used for conversion of a memory operand. As an example, “−1” is an initial value and indicates non-use.

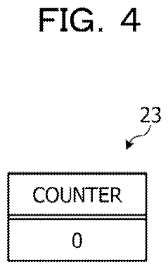

Returning to FIG. 1, the counter 23 is a counter that counts up each time a CISC instruction is converted. An example of the counter 23 will be described with reference to FIG. 4.

FIG. 4 is a diagram illustrating an example of the counter according to the embodiment. As illustrated in FIG. 4, the counter 23 is incremented by 1 each time conversion is performed. As an example, “0” is an initial value and indicates that conversion has not been performed yet.

Returning to FIG. 1, the saving area 24 is a memory area used as a saving destination when the value stored in a vector register is saved.

The initialization unit 11 initializes the register management table 21, the reference idx 22, and the counter 23 used for conversion. For example, the initialization unit 11 sets an available vector register idx in the register management table 21, and sets an initial value for the previous reference corresponding to the vector register idx. The initialization unit 11 sets an initial value for the reference idx 22. The initialization unit 11 sets an initial value for the counter 23.

The instruction acquisition unit 12 acquires a CISC instruction to be converted into a RISC instruction. For example, the instruction acquisition unit 12 reads a target file. The instruction acquisition unit 12 sequentially acquires, from the read file, CISC instructions to be converted.

The instruction determination unit 13 determines whether the acquired CISC instruction is an instruction with a memory operand. When the acquired CISC instruction is an instruction with a memory operand, the instruction determination unit 13 transitions to the register selection unit 14 to process the instruction with a memory operand. When the acquired CISC instruction is not an instruction with a memory operand, the instruction determination unit 13 transitions to the equivalent instruction generation unit 18.

Based on the register management table 21, the register selection unit 14 selects a vector register to be used for conversion of a memory operand. For example, the register selection unit 14 updates the previous reference in the register management table 21 with the value of the counter 23 for the vector register idx corresponding to the vector register to be used for conversion. When the reference idx 22 storing a vector register idx to be used for conversion of a memory operand is an initial value, the register selection unit 14 uses the register management table 21 and selects a vector register idx by a predetermined selection method. The register selection unit 14 updates the reference idx 22 with the selected vector register idx. When the reference idx 22 is not an initial value, since a vector register idx is already selected, the register selection unit 14 does not select a vector register idx.

The predetermined selection method will be described. The predetermined selection method is performed as follows on the assumption that a vector register idx not to be used for conversion is selected from among the vector register idxes in the register management table 21. For example, in the processing of the selection method, the vector register idx for which the previous reference indicates the smallest value is selected. For example, in the processing of the selection method, an unused vector register idx is preferentially used. When there is no unused vector register idx, the vector register idx of the oldest conversion timing is selected. When there is a plurality of selection targets, the smallest vector register idx or the largest vector register idx is selected in the processing of the selection method. In the embodiment, the vector register idx for which the previous reference indicates the smallest value is selected in the processing of the selection method. However, when there is a plurality of smallest values, the smallest vector register idx is selected.

When a vector register to be used for conversion of a memory operand has been used before, the data saving unit 15 generates a store instruction for saving the data stored in the vector register. For example, the data saving unit 15 performs the following processing for the vector register idx selected by the register selection unit 14. For example, when the corresponding value of previous reference in the register management table 21 is a positive value, since the corresponding register indicated by the vector register idx has been used before, the data saving unit 15 generates a store instruction for saving the data stored in the corresponding register to the saving area 24. When the value of previous reference in the register management table 21 is an initial value, since the corresponding register indicated by the vector register idx has not been used before, the data saving unit 15 does not generate a store instruction for saving the data stored in the corresponding register.

Accordingly, even when a vector register to be used for conversion of a memory operand is selected by the register selection unit 14, the data saving unit 15 does not save the data unless the vector register has been used before, so that the number of times of issuance of saving instructions may be reduced.

To convert a memory operand, the data reading unit 16 generates a load instruction for reading data into a vector register to be used for the conversion of the memory operand. For example, the data reading unit 16 generates a load instruction for reading data to be memory-accessed into a vector register indicated by a vector register idx stored in the reference idx 22.

When a vector register to be used for conversion of a memory operand is used at the time of converting a new CISC instruction with a memory operand, the data restoration unit 17 generates a load instruction for restoring data to the vector register in accordance with a predetermined condition. For example, when the reference idx 22 is not an initial value, the data restoration unit 17 determines whether the corresponding register of a vector register idx stored in the reference idx 22 is used in a CISC instruction to be converted. When the corresponding register of a vector register idx stored in the reference idx 22 is used in the CISC instruction to be converted, the data restoration unit 17 performs the following processing. For example, when the value of previous reference in the register management table 21 is a positive value for a vector register idx stored in the reference idx 22, since the vector register has been used before, the data restoration unit 17 generates a load instruction for restoring data to the corresponding register. When the value of previous reference in the register management table 21 is an initial value, since the vector register has not been used before, the data restoration unit 17 does not generate a load instruction for restoring data to the corresponding register. The data restoration unit 17 updates the reference idx 22 to an initial value. The reference idx 22 is updated to an initial value for causing the register selection unit 14 to newly select a vector register to be used for conversion of a memory operand.

Accordingly, at the time of conversion of a new instruction, even when a vector register to be used for conversion of a memory operand is used in the instruction, the data restoration unit 17 does not restore data unless the vector register has been used before, and thus the number of times of issuance of restoration instructions may be reduced.

When the corresponding register of a vector register idx stored in the reference idx 22 is not used in the CISC instruction to be converted, the data restoration unit 17 does not generate a load instruction for restoring data to the corresponding register. This is because the corresponding register of a vector register idx stored in the reference idx 22 is used repeatedly for conversion of a new memory operand.

Accordingly, at the time of conversion of a new instruction, the data restoration unit 17 does not restore data unless a vector register to be used for conversion of a memory operand is used for the instruction, and thus the number of times of issuance of restoration instructions may be reduced.

The equivalent instruction generation unit 18 generates a RISC instruction equivalent to a CISC instruction. For example, when the data reading unit 16 generates a load instruction for reading data into a vector register to be used for conversion of a memory operand, the equivalent instruction generation unit 18 generates a RISC instruction equivalent to a CISC instruction using the vector register. The equivalent instruction generation unit 18 increments the counter 23 each time conversion of a CISC instruction is performed.

[Example of Conversion Processing]

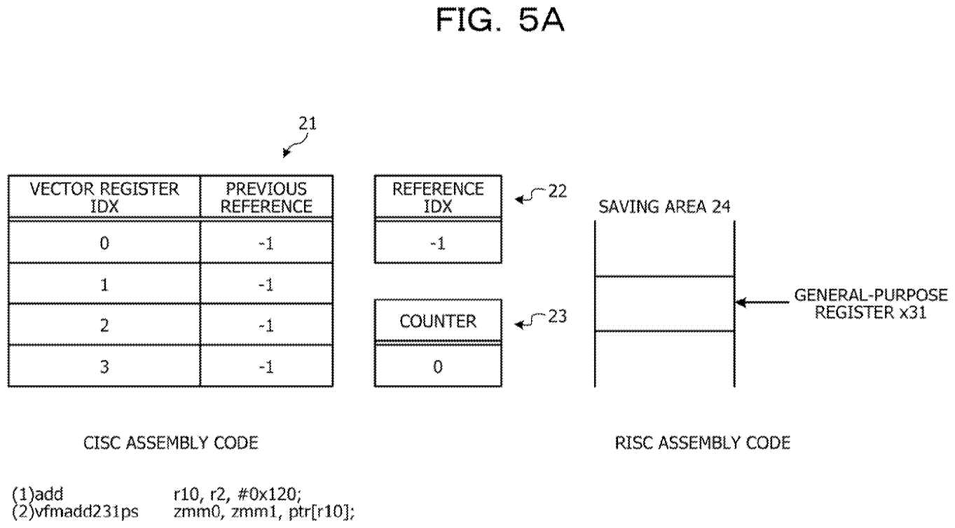

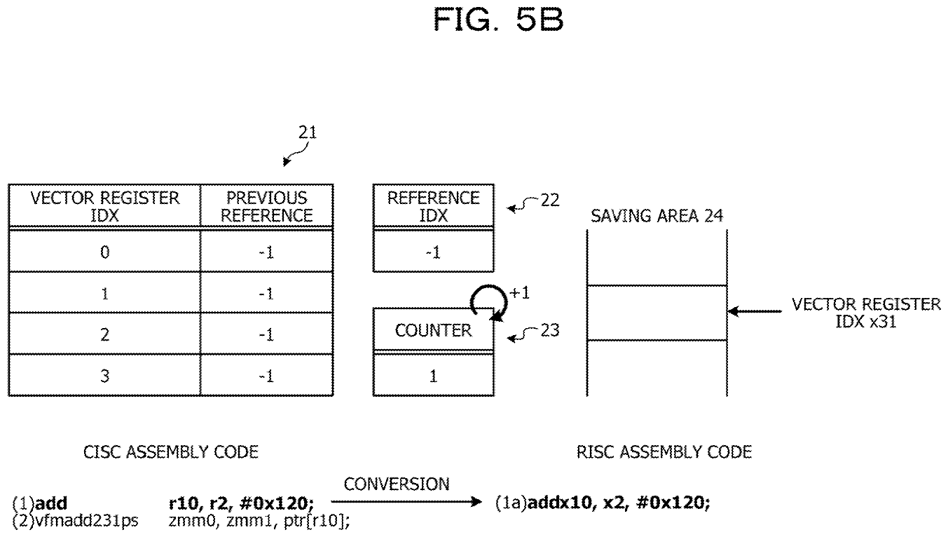

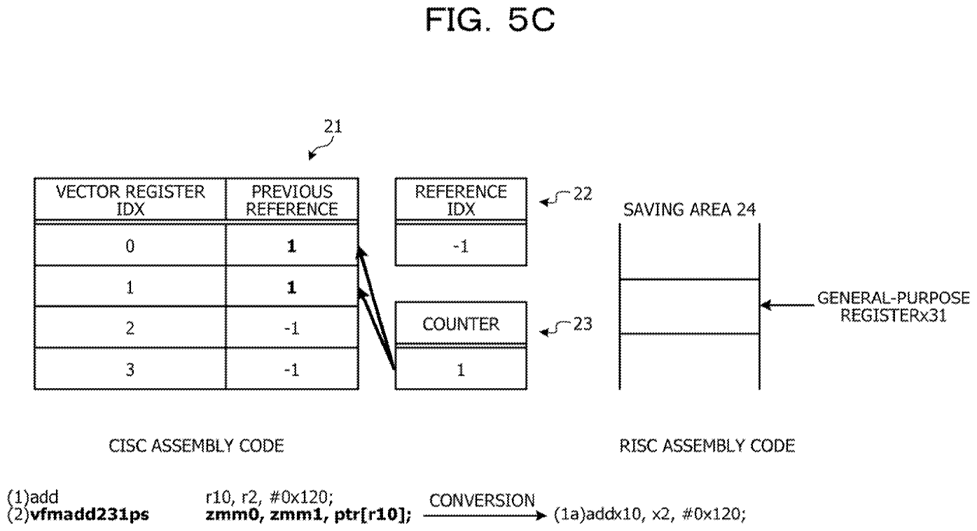

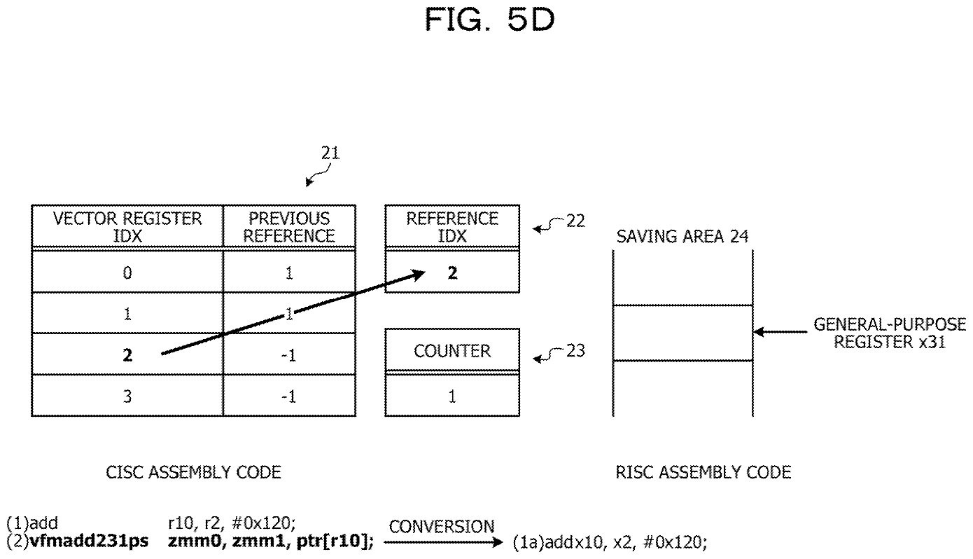

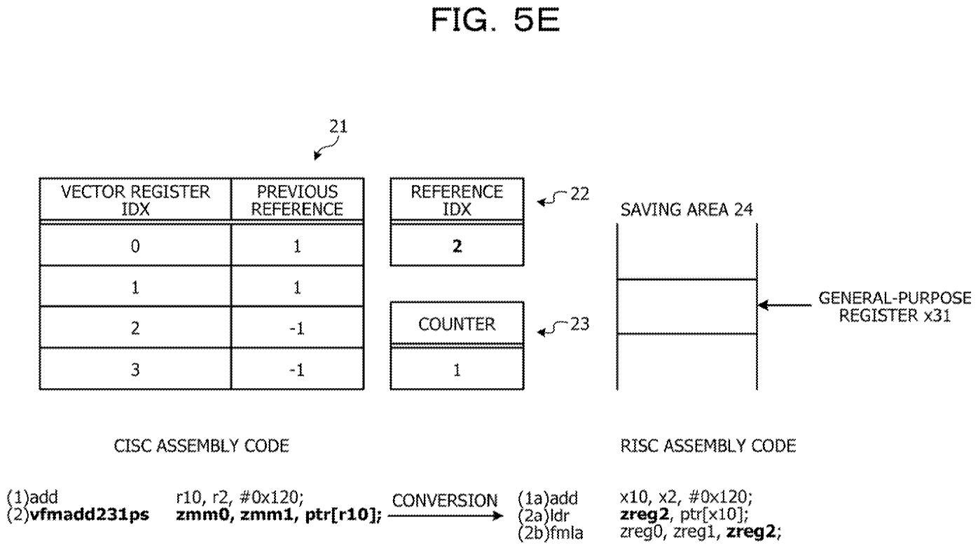

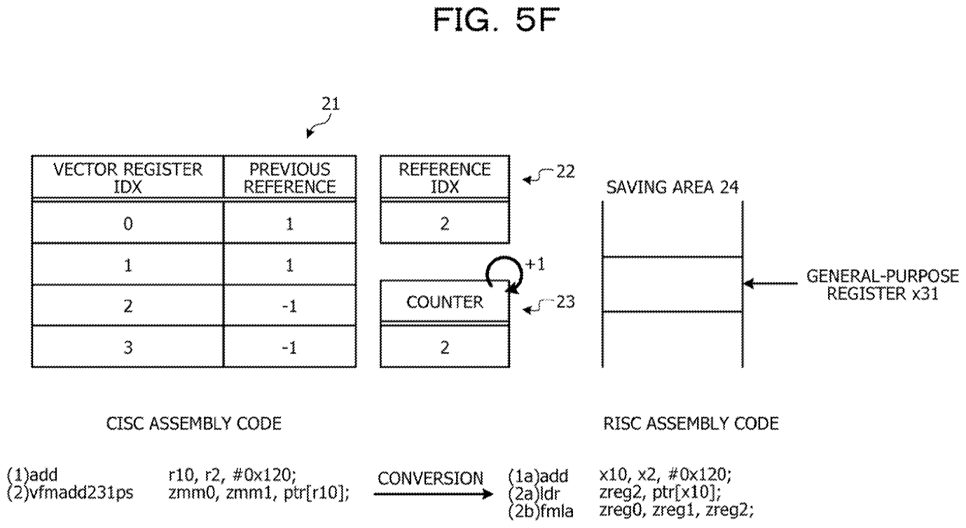

An example of conversion processing to be executed by the information processing apparatus 1 will be described with reference to FIGS. 5A to 5F. FIGS. 5A to 5F are diagrams illustrating an example of the conversion processing according to the embodiment. In FIGS. 5A to 5F, conversion processing to be executed when the CISC assembly code is the following instructions (1) and (2) will be described. In the instructions (1) and (2), r10 and r2 are registers of 512 bits, and zmm0 and zmm1 are vector registers of 512 bits. add r10, r2, #0x120; . . . (1) vfmadd231ps zmm0, zmm1, ptr[r10]; . . . (2)

The instruction (1) is an add instruction “r10←r2+0x120”. For example, the instruction (1) is an instruction for adding the constant 0x120 to the value of the register r2 and storing the result in the register r10. The instruction (2) is a multiply-add instruction “zmm0←zmm0+zmm1× ptr[r10]”. For example, the instruction (2) is an instruction for reading 512 bits by performing memory access using the value of register r10 as an address, multiplying the read value by the value of vector register zmm1, adding the multiplication result to the value of vector register zmm0, and storing the result in zmm0. “ptr[r10]” in the instruction (2) is a memory operand.

As illustrated in FIG. 5A, the initialization unit 11 sets available vector register idxes in the register management table 21, and sets initial values for the previous references corresponding to the vector register idxes. In the register management table 21, 0 to 3 are set as available vector register idxes. An initial value “−1” is set for all previous references corresponding to the vector register idxes. The initialization unit 11 sets initial values for the reference idx 22 and the counter 23. An initial value “−1” is set for the reference idx 22. An initial value “0” is set for the counter 23.

As illustrated in FIG. 5B, the instruction acquisition unit 12 acquires the instruction (1) as an assembly code to be converted from CISC to RISC. The instruction determination unit 13 determines whether the instruction (1) is an instruction with a memory operand. Since the instruction (1) does not have a memory operand, it is determined that the instruction (1) is not an instruction with a memory operand. The equivalent instruction generation unit 18 generates a RISC instruction equivalent to a CISC instruction for the instruction (1). A RISC assembly code is generated as in the following instruction (1a). For example, the instruction (1a) is an instruction for adding the constant 0x120 to the value of register x2 and storing the result in the register x10. add x10, x2, #0x120; . . . (1a)

The equivalent instruction generation unit 18 increments the counter 23. The counter 23 is updated from 0 to 1.

As illustrated in FIG. 5C, the instruction acquisition unit 12 acquires the instruction (2) as an assembly code to be converted from CISC to RISC. The instruction determination unit 13 determines whether the instruction (2) is an instruction with a memory operand. Since the instruction (2) includes the memory operand “ptr[r10]”, it is determined that the instruction (2) is an instruction with a memory operand.

The register selection unit 14 updates the previous reference in the register management table 21 with the value of the counter 23 for the vector register idx corresponding to the vector register to be used for conversion. In the instruction (2), the vector registers to be used for conversion are zmm0 and zmm1. Accordingly, the register selection unit 14 updates the previous reference in the register management table 21 with the value “1” of the counter 23 for the vector register idx “0” corresponding to zmm0 and the vector register idx “1” corresponding to zmm1.

As illustrated in FIG. 5D, when the reference idx 22 is “−1” indicating an initial value, the register selection unit 14 uses the register management table 21 and selects a vector register idx by a predetermined selection method, and updates the reference idx 22 with the selected vector register idx. The selection method is to select the vector register idx for which the previous reference indicates the smallest value, and to select the smallest vector register idx when there is a plurality of smallest values. Accordingly, the vector register idx “2” for which the previous reference indicates the smallest value “−1” is selected, and the reference idx 22 is updated to “2”.

As illustrated in FIG. 5E, when the value of previous reference in the register management table 21 is a positive value for the selected vector register idx, the data saving unit 15 generates a store instruction for saving the data stored in the vector register of the vector register idx. The value of previous reference in the register management table 21 is “−1” indicating an initial value and is not a positive value for the selected vector register idx “2”. Accordingly, the data saving unit 15 does not generate a store instruction for saving the data stored in the vector register of the vector register idx “2”. Accordingly, even when a vector register to be used for conversion of a memory operand is selected by the register selection unit 14, the data saving unit 15 does not save the data unless the vector register has been used before, so that the number of times of issuance of saving instructions may be reduced.

The data reading unit 16 generates a load instruction for reading data to be memory-accessed into the vector register indicated by the vector register idx “2” stored in the reference idx 22. A RISC assembly code is generated as in the following instruction (2a). In the instruction (2a), zreg2 is a vector register indicated by the vector register idx “2”, and is a vector register of 512 bits. ptr[x10] is data obtained by performing memory access using the value of register x10 as an address and reading 512 bits. According to the instruction (2a), the data read by memory access is loaded into the vector register zreg2. Idr zreg2, ptr[x10]; . . . (2a)

A RISC assembly code is generated as in the following instruction (2b). For example, the instruction (2b) is an instruction for multiplying the value of vector register zreg2 of the instruction (2a) by the value of vector register zreg1, adding the multiplication result to the value of vector register zreg0, and storing the result in zreg0. fmla zreg0, zreg1, zreg2; . . . (2b)

As illustrated in FIG. 5F, the equivalent instruction generation unit 18 increments the counter 23. The counter 23 is updated from 1 to 2.

As described above, by using the register management table 21, the reference idx 22, and the counter 23, the information processing apparatus 1 may reduce the number of times of data saving that occurs when a CISC instruction with a memory operand is converted into a RISC instruction.

[Another Example of Conversion Processing]

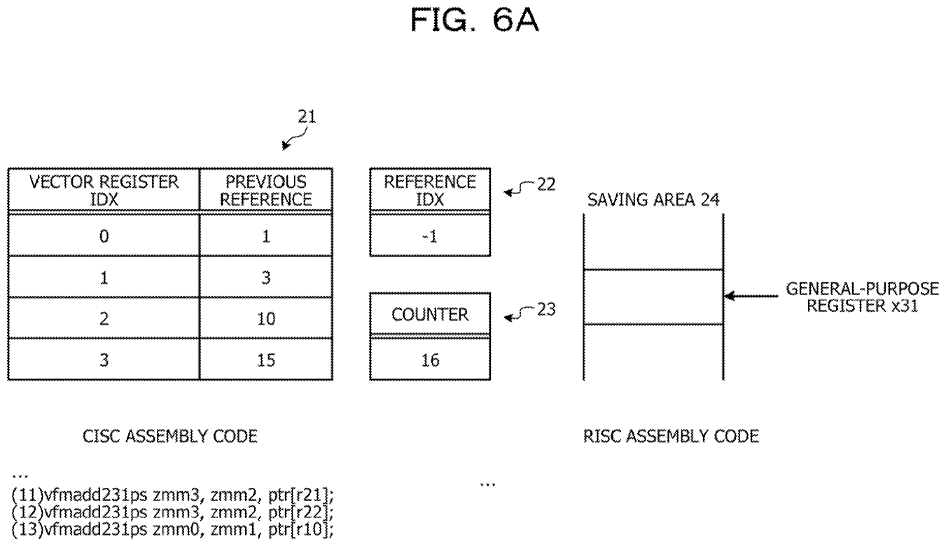

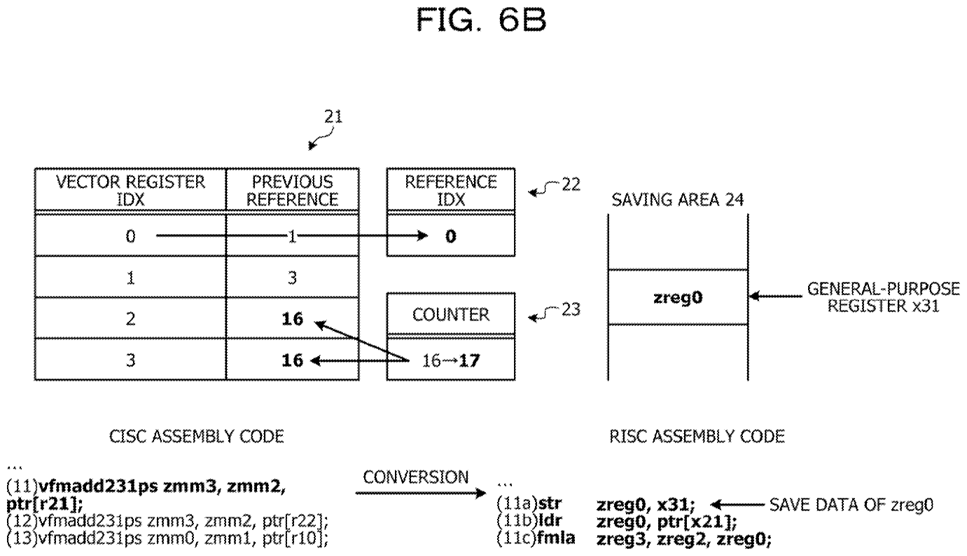

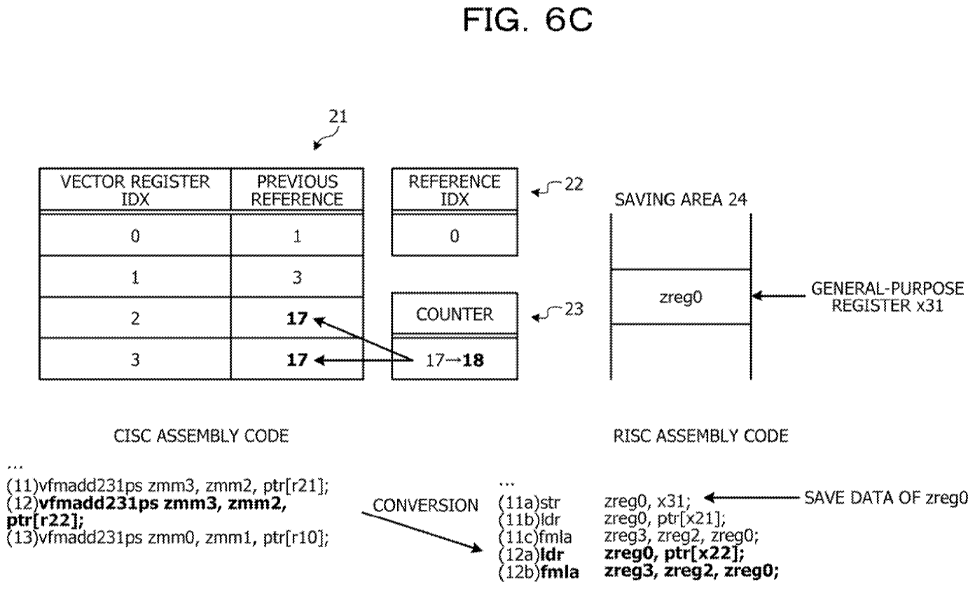

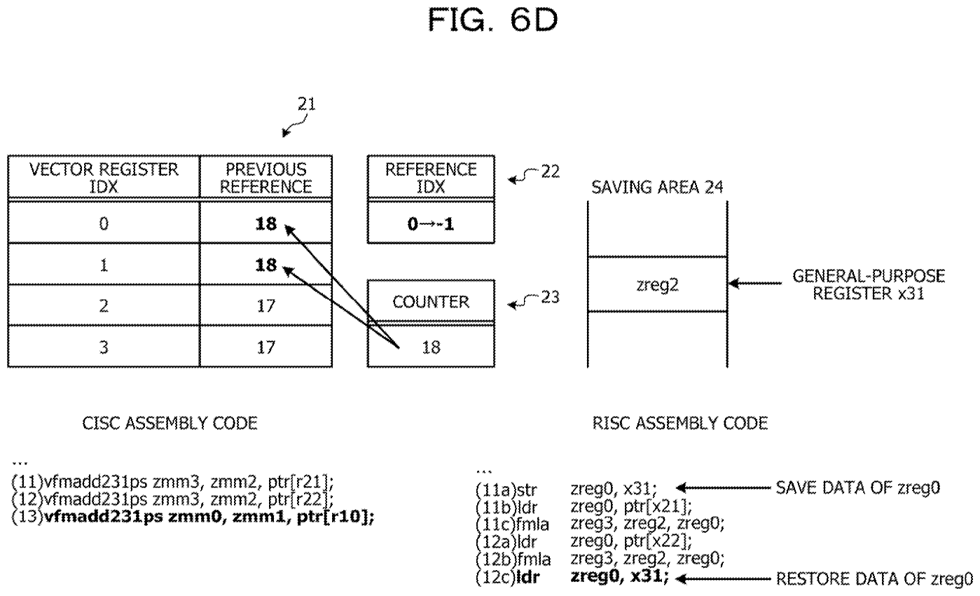

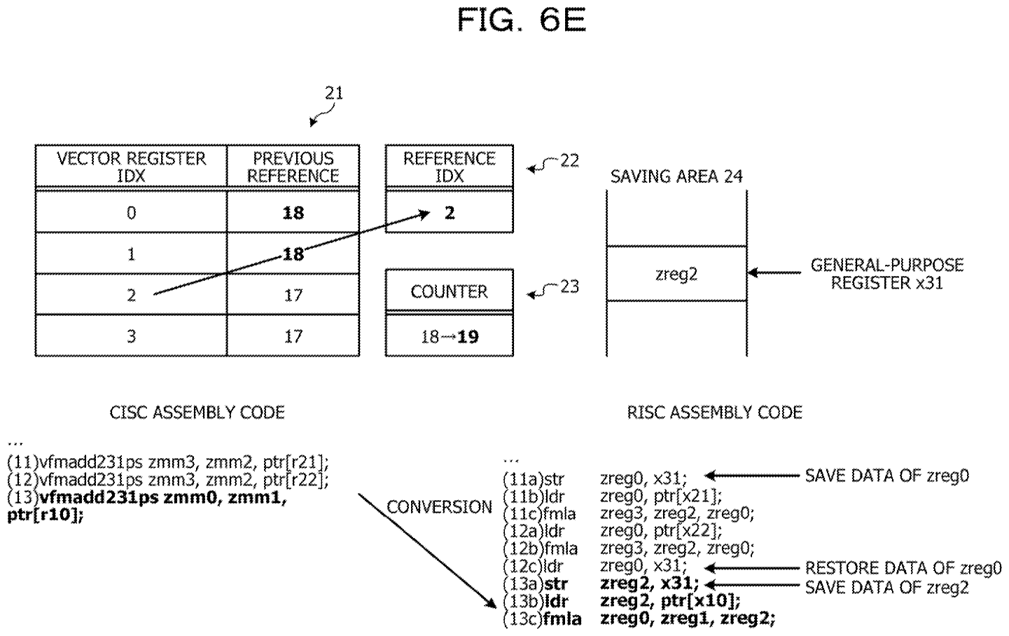

Next, another example of conversion processing to be executed by the information processing apparatus 1 will be described with reference to FIGS. 6A to 6E. FIGS. 6A to 6E are diagrams illustrating another example of the conversion processing according to the embodiment. In FIGS. 6A to 6E, conversion processing to be executed when the CISC assembly code is the following instructions (11), (12), and (13) will be described. In the instructions (11), (12), and (13), r10, r21, and r22 are registers of 512 bits, and zmm0, zmm1, zmm2, and zmm3 are vector registers of 512 bits. vfmadd231ps zmm3, zmm2, ptr[r21]; . . . (11) vfmadd231ps zmm3, zmm2, ptr[r22]; . . . (12) vfmadd231ps zmm0, zmm1, ptr[r10]; . . . (13)

Since the instructions (11), (12), and (13) include different registers but have the same function as the instruction (2), description of the details of the instructions will be omitted.

As illustrated in FIG. 6A, in the register management table 21, 0 to 3 are set as available vector register idxes. “1” is set for the previous reference corresponding to the vector register idx “0”. “3” is set for the previous reference corresponding to the vector register idx “1”. “10” is set for the previous reference corresponding to the vector register idx “2”. “15” is set for the previous reference corresponding to the vector register idx “3”. An initial value “−1” is set for the reference idx 22 storing a vector register idx to be used for conversion of a memory operand. “16” is set for the counter 23.

As illustrated in FIG. 6B, the instruction acquisition unit 12 acquires the instruction (11) as an assembly code to be converted from CISC to RISC. The instruction determination unit 13 determines whether the instruction (11) is an instruction with a memory operand. Since the instruction (11) includes the memory operand “ptr[r21]”, it is determined that the instruction (11) is an instruction with a memory operand.

The register selection unit 14 updates the previous reference in the register management table 21 with the value of the counter 23 for the vector register idx corresponding to the vector register to be used for conversion. In the instruction (11), the vector registers to be used for conversion are zmm3 and zmm2. Accordingly, the register selection unit 14 updates the previous reference in the register management table 21 with the value “16” of the counter 23 for the vector register idx “3” corresponding to zmm3 and the vector register idx “2” corresponding to zmm2.

When the reference idx 22 is “−1” indicating an initial value, the register selection unit 14 uses the register management table 21 and selects a vector register idx by a predetermined selection method, and updates the reference idx 22 with the selected vector register idx. Since the reference idx 22 is “−1” indicating an initial value, a vector register idx is selected. The selection method is to select the vector register idx for which the previous reference indicates the smallest value, and to select the smallest vector register idx when there is a plurality of smallest values. Accordingly, the vector register idx “0” for which the previous reference indicates the smallest value “1” is selected, and the reference idx 22 is updated to “0”.

When the value of previous reference in the register management table 21 is a positive value for the selected vector register idx, since the vector register has been used before, the data saving unit 15 generates a store instruction for saving the data stored in the corresponding register of the vector register idx. The value of previous reference in the register management table 21 is “1”, which is a positive value, for the selected vector register idx “0”. Accordingly, the data saving unit 15 generates a store instruction for saving the data stored in the vector register of the vector register idx “0”. A RISC assembly code is generated as in the following instruction (11a). In the instruction (11a), zreg0 is a vector register indicated by the vector register idx “0”, and is a vector register of 512 bits. According to the instruction (11a), the data stored in zreg0 is saved to the saving area 24 using the value of general-purpose register x31 as an address. str zreg0, x31; . . . (11a)

The data reading unit 16 generates a load instruction for reading data to be memory-accessed into the vector register indicated by the vector register idx “0” stored in the reference idx 22. A RISC assembly code is generated as in the following instruction (11b). In the instruction (11b), zreg0 is a vector register indicated by the vector register idx “0”, and is a vector register of 512 bits. ptr[x21] is data obtained by performing memory access using the value of register x21 as an address and reading 512 bits. According to the instruction (11b), the data read by memory access is loaded into the vector register zreg0. Idr zreg0, ptr[x21]; . . . (11b)

The equivalent instruction generation unit 18 generates a RISC instruction equivalent to a CISC instruction for the instruction (11). A RISC assembly code is generated as in the following instruction (11c). For example, the instruction (11c) is an instruction for multiplying the value of vector register zreg0 of the instruction (11b) by the value of vector register zreg2, adding the multiplication result to the value of vector register zreg3, and storing the result in zreg3. fmla zreg3, zreg2, zreg0; . . . (11c)

The equivalent instruction generation unit 18 increments the counter 23. The counter 23 is updated from 16 to 17.

As illustrated in FIG. 6C, the instruction acquisition unit 12 acquires the instruction (12) as an assembly code to be converted from CISC to RISC. The instruction determination unit 13 determines whether the instruction (12) is an instruction with a memory operand. Since the instruction (12) includes the memory operand ptr[r22], it is determined that the instruction (12) is an instruction with a memory operand.

When the reference idx 22 is not an initial value, the data restoration unit 17 determines whether the corresponding register of a vector register idx stored in the reference idx 22 is used in a CISC instruction to be converted. When the corresponding register of a vector register idx stored in the reference idx 22 is used in the CISC instruction to be converted, the data restoration unit 17 performs the following processing. When the value of previous reference in the register management table 21 is a positive value for a vector register idx stored in the reference idx 22, the data restoration unit 17 generates a load instruction for restoring data to the corresponding register. The reference idx 22 is “0”, which is not an initial value. Additionally, the vector register of the vector register idx “0” indicated by the reference idx 22 is not used in the instruction (12). For this reason, in such a case, the data restoration unit 17 does not generate a load instruction for restoring data to the corresponding register. Accordingly, at the time of conversion of a new instruction, even when a vector register to be used for conversion of a memory operand is already used, the data restoration unit 17 does not restore data unless the vector register is used in the new instruction, and thus the number of times of issuance of restoration instructions may be reduced.

The register selection unit 14 updates the previous reference in the register management table 21 with the value of the counter 23 for the vector register idx corresponding to the vector register to be used for conversion. In the instruction (12), the vector registers to be used for conversion are zmm3 and zmm2. Accordingly, the register selection unit 14 updates the previous reference in the register management table 21 with the value “17” of the counter 23 for the vector register idx “3” corresponding to zmm3 and the vector register idx “2” corresponding to zmm2.

Since the reference idx 22 is not an initial value, the register selection unit 14 skips saving of the data of the vector register of the vector register idx “0” stored in the reference idx 22, and proceeds to the next data reading processing. Accordingly, when a vector register to be used for conversion of a memory operand (“0” in this case) is already selected, the data saving unit 15 does not save the data unless the vector register is used in the current instruction, so that the number of times of issuance of saving instructions may be reduced.

The data reading unit 16 generates a load instruction for reading data to be memory-accessed into the vector register indicated by the vector register idx “0” stored in the reference idx 22. Idr zreg0, ptr[x22]; . . . (12a)

The equivalent instruction generation unit 18 generates a RISC instruction equivalent to a CISC instruction for the instruction (12). A RISC assembly code is generated as in the following instruction (12b). For example, the instruction (12b) is an instruction for multiplying the value of vector register zreg0 of the instruction (12a) by the value of vector register zreg2, adding the multiplication result to the value of vector register zreg3, and storing the result in zreg3. fmla zreg3, zreg2, zreg0; . . . (12b)

The equivalent instruction generation unit 18 increments the counter 23. The counter 23 is updated from 17 to 18.

As illustrated in FIG. 6D, the instruction acquisition unit 12 acquires the instruction (13) as an assembly code to be converted from CISC to RISC. The instruction determination unit 13 determines whether the instruction (13) is an instruction with a memory operand. Since the instruction (13) includes the memory operand ptr[r10], it is determined that the instruction (13) is an instruction with a memory operand.

When a vector register to be used for conversion of a memory operand is used at the time of converting a new CISC instruction with a memory operand, the data restoration unit 17 generates a load instruction for restoring data to the vector register in accordance with a predetermined condition. For example, when the reference idx 22 is not an initial value, the data restoration unit 17 determines whether the corresponding register of a vector register idx stored in the reference idx 22 is used in a CISC instruction to be converted. When the corresponding register of a vector register idx stored in the reference idx 22 is used in the CISC instruction to be converted, the data restoration unit 17 performs the following processing. For example, when the value of previous reference in the register management table 21 is a positive value for a vector register idx stored in the reference idx 22, the data restoration unit 17 generates a load instruction for restoring data to the corresponding register. The reference idx 22 is “0”, which is not an initial value. However, the vector register of the vector register idx “0” indicated by the reference idx 22 is used in the instruction (13). The vector register being used is “zmm0”. For this reason, in such a case, the data restoration unit 17 generates a load instruction for restoring data to the corresponding register of the vector register idx “0”. A load instruction to be generated is generated as in the following instruction (12c). In the instruction (12c), zreg0 is a vector register indicated by the vector register idx “0”, and is a vector register of 512 bits. x31 is a general-purpose register of the saving area. According to the instruction (12c), the data saved to the saving area 24 using the value of general-purpose register x31 as an address is restored to zreg0. Idr zreg0, x31; . . . (12c)

The data restoration unit 17 updates the reference idx 22 to an initial value. The reference idx 22 is updated from “0” to “−1” indicating an initial value.

The register selection unit 14 updates the previous reference in the register management table 21 with the value of the counter 23 for the vector register idx corresponding to the vector register to be used for conversion. In the instruction (13), the vector registers to be used for conversion are zmm0 and zmm1. Accordingly, the register selection unit 14 updates the previous reference in the register management table 21 with the value “18” of the counter 23 for the vector register idx “0” corresponding to zmm0 and the vector register idx “1” corresponding to zmm1.

As illustrated in FIG. 6E, when the reference idx 22 is “−1” indicating an initial value, the register selection unit 14 uses the register management table 21 and selects a vector register idx by a predetermined selection method, and updates the reference idx 22 with the selected vector register idx. Since the reference idx 22 is “−1” indicating an initial value, the vector register idx “2” is selected based on the predetermined selection method, and the reference idx 22 is updated to “2”.

When the value of previous reference in the register management table 21 is a positive value for the selected vector register idx, since the vector register has been used before, the data saving unit 15 generates a store instruction for saving the data stored in the corresponding register of the vector register idx. The value of previous reference in the register management table 21 is “17”, which is a positive value, for the selected vector register idx “2”. Accordingly, the data saving unit 15 generates a store instruction for saving the data stored in the vector register of the vector register idx “2”. A RISC assembly code is generated as in the following instruction (13a). In the instruction (13a), zreg2 is a vector register indicated by the vector register idx “2”, and is a vector register of 512 bits. According to the instruction (13a), the data stored in zreg2 is saved to the saving area 24 using the value of general-purpose register x31 as an address. str zreg2, x31; . . . (13a)

The data reading unit 16 generates a load instruction for reading data to be memory-accessed into the vector register indicated by the vector register idx “2” stored in the reference idx 22. A RISC assembly code is generated as in the following instruction (13b). In the instruction (13b), zreg2 is a vector register indicated by the vector register idx “2”, and is a vector register of 512 bits. ptr[x10] is data obtained by performing memory access using the value of register x10 as an address and reading 512 bits. According to the instruction (13b), the data read by memory access is loaded into the vector register zreg2. Idr zreg2, ptr[x10]; . . . (13b)

The equivalent instruction generation unit 18 generates a RISC instruction equivalent to a CISC instruction for the instruction (13). A RISC assembly code is generated as in the following instruction (13c). For example, the instruction (13c) is an instruction for multiplying the value of vector register zreg2 of the instruction (13b) by the value of vector register zreg1, adding the multiplication result to the value of vector register zreg0, and storing the result in zreg0. fmla zreg0, zreg1, zreg2; . . . (13c)

The equivalent instruction generation unit 18 increments the counter 23. The counter 23 is updated from 18 to 19.

As described above, by using the register management table 21, the reference idx 22, and the counter 23, the information processing apparatus 1 may reduce the number of times of data saving and the number of times of data restoration that occur when a CISC instruction with a memory operand is converted into a RISC instruction.

[Flowchart of Conversion Processing]

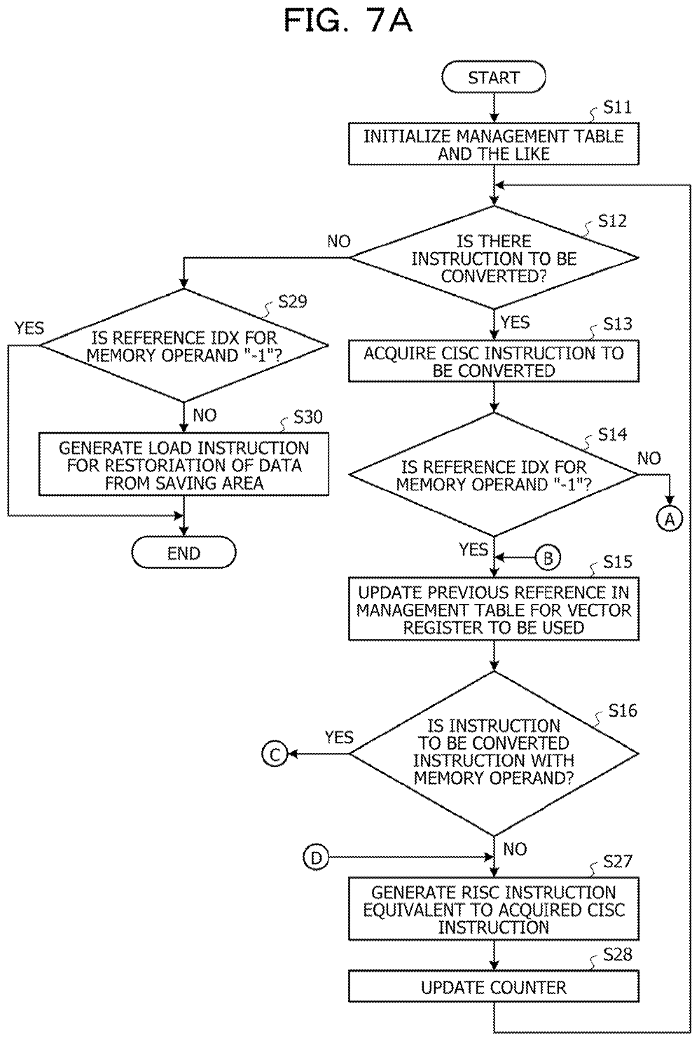

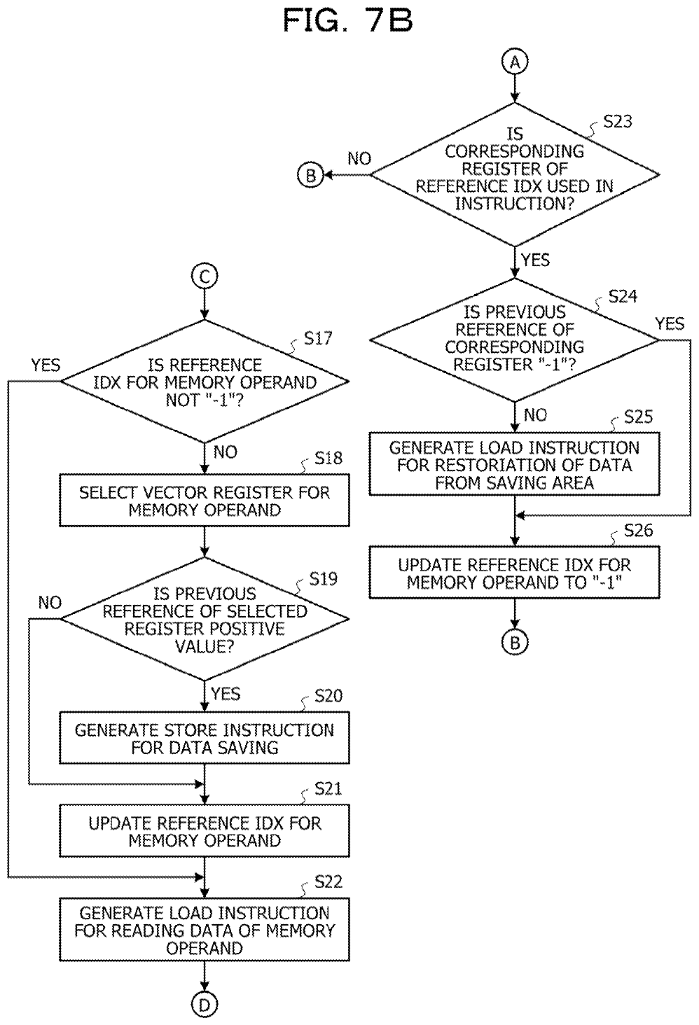

FIGS. 7A and 7B are a diagram illustrating an example of a flowchart of the conversion processing according to the embodiment. As illustrated in FIGS. 7A and 7B, the information processing apparatus 1 initializes the register management table 21 and the like (step S11). For example, the initialization unit 11 sets an available vector register idx in the register management table 21, and sets “−1” as an initial value for the previous reference corresponding to the vector register idx. The initialization unit 11 sets “−1” as an initial value for the reference idx 22. The initialization unit 11 sets “0” as an initial value for the counter 23.

The information processing apparatus 1 determines whether there is an instruction to be converted from CISC to RISC (step S12). When it is determined that there is an instruction to be converted (step S12; Yes), the information processing apparatus 1 acquires a CISC instruction to be converted (step S13). The information processing apparatus 1 determines whether the reference idx 22 for memory operand is “−1” indicating an initial value (step S14).

When it is determined that the reference idx 22 for memory operand is “−1” (step S14; Yes), the information processing apparatus 1 updates the previous reference in the register management table 21 for the vector register to be used for conversion (step S15). For example, the register selection unit 14 updates the previous reference in the register management table 21 with the value of the counter 23 for the vector register idx corresponding to the vector register to be used for conversion.

The information processing apparatus 1 determines whether the CISC instruction to be converted is an instruction with a memory operand (step S16). When it is determined that the CISC instruction to be converted is not an instruction with a memory operand (step S16; No), the information processing apparatus 1 proceeds to step S27 to convert the CISC instruction as it is.

On the other hand, when it is determined that the CISC instruction to be converted is an instruction with a memory operand (step S16; Yes), the information processing apparatus 1 determines whether the reference idx 22 for memory operand is not “−1” indicating an initial value (step S17). When it is determined that the reference idx 22 for memory operand is not “−1” (step S17; Yes), the information processing apparatus 1 does not save the data of the vector register indicated by the reference idx 22, and proceeds to step S22.

On the other hand, when it is determined that the reference idx 22 for memory operand is “−1” (step S17; No), the information processing apparatus 1 selects a vector register for memory operand (step S18). For example, the register selection unit 14 uses the register management table 21 and selects a vector register idx by a predetermined selection method.

The information processing apparatus 1 determines whether the previous reference of the selected vector register is a positive value (step S19). For example, the data saving unit 15 determines whether the value of previous reference in the register management table 21 is a positive value for the selected vector register idx.

When it is determined that the previous reference of the selected vector register is a positive value (step S19; Yes), the information processing apparatus 1 generates a store instruction for data saving for the selected vector register (step S20). For example, when the value of previous reference in the register management table 21 is a positive value, the data saving unit 15 generates a store instruction for saving the data stored in the vector register indicated by the selected vector register idx to the saving area 24. The information processing apparatus 1 proceeds to step S21.

On the other hand, when it is determined that the previous reference of the selected vector register is not a positive value (step S19; No), the information processing apparatus 1 does not save the data of the selected vector register, and proceeds to step S21.

In step S21, the information processing apparatus 1 updates the reference idx 22 for memory operand (step S21). For example, the register selection unit 14 updates the reference idx 22 with the selected vector register idx. The information processing apparatus 1 proceeds to step S22.

In step S22, the information processing apparatus 1 generates a load instruction for reading data of a memory operand (step S22). For example, the data reading unit 16 generates a load instruction for reading data to be memory-accessed into a vector register indicated by a vector register idx stored in the reference idx 22. The information processing apparatus 1 proceeds to step S27 to convert the CISC instruction.

In step S14, when it is determined that the reference idx 22 for memory operand is not “−1” (step S14; No), the information processing apparatus 1 determines whether the corresponding register of the reference idx 22 is used in the instruction (step S23). For example, when the reference idx 22 is not an initial value, the data restoration unit 17 determines whether the corresponding register of a vector register idx stored in the reference idx 22 is used in a CISC instruction to be converted.

When it is determined that the corresponding register of the reference idx 22 is not used in the instruction (step S23; No), the information processing apparatus 1 does not restore data to the vector register indicated by the reference idx 22, and proceeds to step S15.

On the other hand, when it is determined that the corresponding register of the reference idx 22 is used in the instruction (step S23; Yes), the information processing apparatus 1 determines whether the previous reference of the corresponding register is “−1”, which is an initial value (step S24). For example, the data restoration unit 17 determines whether the value of previous reference in the register management table 21 is an initial value for a vector register idx stored in the reference idx 22.

When it is determined that the previous reference of the corresponding register is “−1” indicating an initial value (step S24; Yes), the information processing apparatus 1 proceeds to step S26 to update the previous reference of the vector register to be used. The information processing apparatus 1 does not restore data to the vector register indicated by the reference idx 22.

On the other hand, when it is determined that the previous reference of the corresponding register is not “−1” indicating an initial value (step S24; No), the information processing apparatus 1 generates a load instruction for restoration of data from the saving area 24 (step S25). For example, when the value of previous reference in the register management table 21 is a positive value for a vector register idx stored in the reference idx 22, the data restoration unit 17 generates a load instruction for restoring data to the corresponding register. The information processing apparatus 1 proceeds to step S26.

In step S26, the information processing apparatus 1 updates the reference idx 22 for memory operand to “−1” indicating an initial value (step S26). The information processing apparatus 1 proceeds to step S15 to update the previous reference of the vector register to be used.

In step S27, the information processing apparatus 1 generates a RISC instruction equivalent to the acquired CISC instruction (step S27). For example, when a load instruction for reading data into a vector register to be used for conversion of a memory operand is generated, the equivalent instruction generation unit 18 generates a RISC instruction equivalent to a CISC instruction using the vector register.

The information processing apparatus 1 updates the counter 23 (step S28). For example, the equivalent instruction generation unit 18 increments the counter 23 each time conversion of a CISC instruction is performed. The information processing apparatus 1 proceeds to step S12 to acquire the next instruction to be converted.

When it is determined in step S12 that there is no instruction to be converted (step S12; No), the information processing apparatus 1 determines whether the reference idx 22 for memory operand is “−1” indicating an initial value (step S29). When it is determined that the reference idx 22 for memory operand is “−1” (step S29; Yes), the information processing apparatus 1 ends the conversion processing.

On the other hand, when it is determined that the reference idx 22 for memory operand is not “−1” (step S29; No), the information processing apparatus 1 generates a load instruction for restoration of data from the saving area 24 (step S30). For example, the data restoration unit 17 generates a load instruction for restoring data to the corresponding register for a vector register idx stored in the reference idx 22. The information processing apparatus 1 ends the conversion processing.

As described above, in the conversion processing according to Embodiment 1, when a register that was used in the previous instruction may be used as a vector register for memory operand at the time of converting a CISC instruction with a memory operand into a RISC instruction, the information processing apparatus 1 may reduce the number of times of data saving (store) and the number of times of data restoration (load) by selecting the register.

In the conversion processing according to Embodiment 1, when a register that was used in the previous instruction may be used as a vector register for memory operand at the time of converting a CISC instruction with a memory operand into a RISC instruction, the information processing apparatus 1 selects the register. On the other hand, when a vector register that was used in the previous instruction may not be used, the information processing apparatus 1 selects the vector register indicating the smallest value of previous reference in the register management table 21 as the register for memory operand. However, when all vector registers are used in an instruction group of CISC instructions and instructions designating the vector registers in ascending order continue to be generated, there is a case in which data saving (store) and data restoration (load) are performed every time.

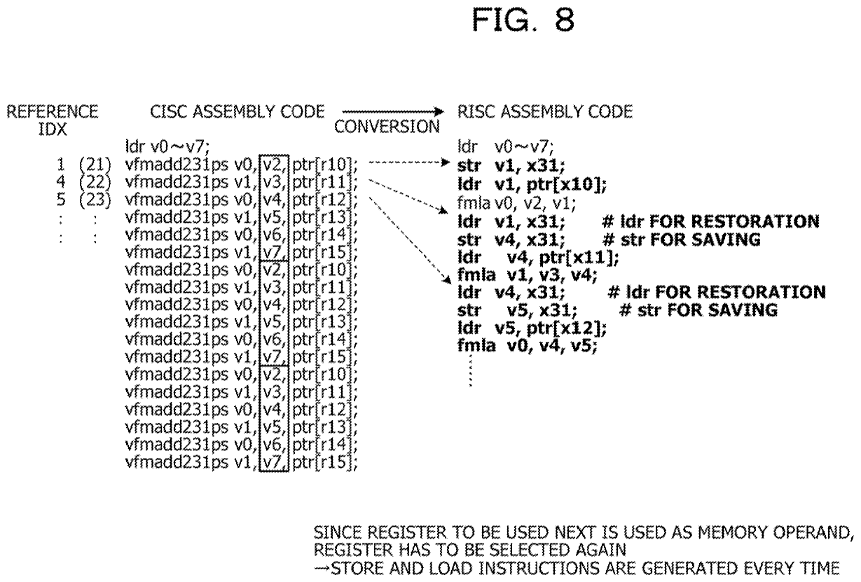

A problem will be described in which, when all vector registers are used in an instruction group of CISC instructions and instructions designating the vector registers in ascending order continue to be generated, data saving (store) and data restoration (load) are performed every time. FIG. 8 is a diagram illustrating a problem of the conversion processing according to Embodiment 1. In FIGS. 8, v0 to v8 are all vector registers. As illustrated in FIG. 8, all vector registers are used in the group of CISC instructions with a memory operand, and the vector registers are used in ascending order from v2. In such a case, in the first instruction (21), v1 is selected as the register for memory operand. For example, the reference idx indicates “1”. In the next instruction (22), since v1 that has been selected as the register for memory operand is used, the vector register “v4” indicating the smallest value of previous reference in the register management table 21 is selected. For example, the reference idx indicates “4”. In the next instruction (23), since v4 that has been selected as the register for memory operand is used, the vector register “v5” indicating the smallest value of previous reference in the register management table 21 is selected. For example, the reference idx indicates “5”. As described above, since a vector register selected as the register for memory operand is used in an instruction to be converted, the vector register may not be reused as the register for memory operand. For example, each time an instruction is converted, the register indicating the smallest value of previous reference in the register management table 21 is selected as the register for memory operand. Thus, each time an instruction is converted, a restoration (load) instruction for restoring data to a vector register and a save (store) instruction for saving the data of the selected vector register are generated.

Accordingly, in Embodiment 2 described below, an information processing apparatus 1 will be described in which the execution performance is improved even when all vector registers are used and instructions designating the vector registers in ascending order are generated. Hereinafter, the register selection method according to Embodiment 1 (the method in which the vector register indicating the smallest value of previous reference is selected) is referred to as a “second selection method”.

### Embodiment 2

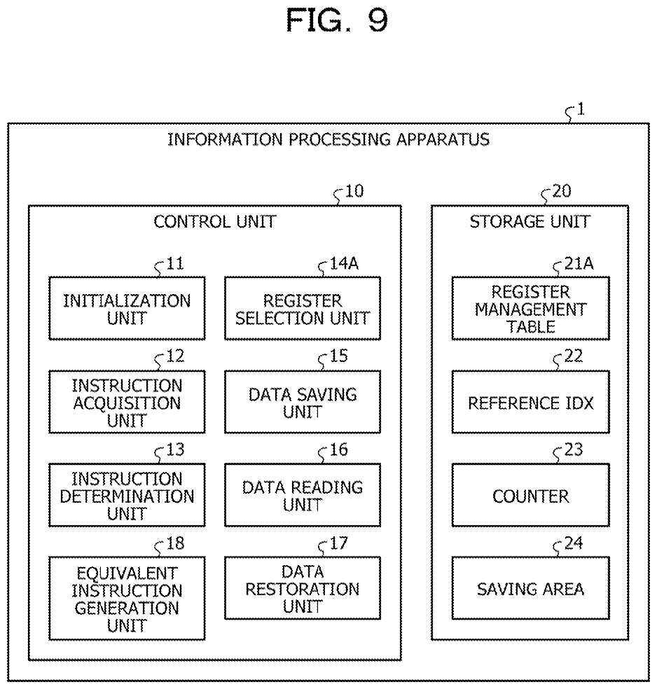

FIG. 9 is a block diagram illustrating an example of a functional configuration of the information processing apparatus according to Embodiment 2. The information processing apparatus 1 according to Embodiment 2 adds, to the register management table 21, interval in which update intervals of previous reference are recorded. After the intervals are recorded for all vector registers, the information processing apparatus 1 switches the register selection method from the second selection method to a first selection method. The “first selection method” referred to herein refers to a method in which a vector register is randomly selected by using interval. As described above, the second selection method referred to herein is the method in which the vector register indicating the smallest value of previous reference is selected.

In the functional configuration of the information processing apparatus 1 according to Embodiment 2, same elements as those of the information processing apparatus 1 illustrated in FIG. 1 are given the same reference signs, and description for the overlapping elements and operation will be omitted. Embodiment 1 and Embodiment 2 are different in that the register selection unit 14 is changed to a register selection unit 14A. Embodiment 1 and Embodiment 2 are different in that the register management table 21 is changed to a register management table 21A.

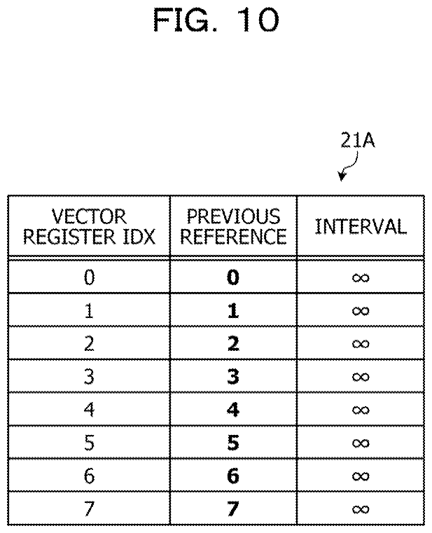

The register management table 21A is a management table in which a vector register idx, previous reference, and an interval are associated with each other. Previous reference indicates the timing at which the register indicating the vector register idx was previously referred to (used). An interval indicates a difference before and after update when previous reference is updated with the value of the counter 23. An initial value of an interval is infinite. An example of the register management table 21A will be described with reference to FIG. 10. FIG. 10 is a diagram illustrating an example of the register management table according to Embodiment 2. As illustrated in FIG. 10, the register management table 21A is information in which a vector register idx, previous reference, and an interval are associated with each other. A vector register idx is an index for uniquely identifying a vector register. The index may be a number. Previous reference indicates the timing at which a register was previously referred to (used). The value of previous reference corresponds to the value of the counter 23. As an example, previous reference indicates that “7” instructions, indicated by the counter 23, have been converted. An interval indicates a difference before and after update when previous reference is updated with the value of the counter 23. As an example, “co” (infinity) is an initial value.

Returning to FIG. 9, based on the register management table 21A, the register selection unit 14A selects a vector register to be used for conversion of a memory operand. For example, when a CISC instruction with a memory operand is converted into a RISC instruction, the register selection unit 14A acquires a vector register idx corresponding to the vector register used in the instruction. The register selection unit 14A updates the previous reference in the register management table 21A with the value of the counter 23 for the acquired vector register idx. Additionally, for the same vector register idx, the register selection unit 14A records, as an interval, the difference before and after the update of the previous reference in the register management table 21A.

When the reference idx 22 storing a vector register idx to be used for conversion of a memory operand is an initial value, the register selection unit 14A selects a vector register idx as follows. When intervals are not fully recorded in the register management table 21A, the register selection unit 14A uses the register management table 21A and selects a vector register idx by the second selection method. For example, the register selection unit 14A uses the register management table 21A and selects the vector register indicating the smallest value of previous reference. When intervals are fully recorded in the register management table 21A, the register selection unit 14A uses the register management table 21A and selects a vector register idx by the first selection method. For example, the register selection unit 14A excludes the vector register used in an instruction from a group of vector registers having the same interval, and randomly selects a vector register. The register selection unit 14A updates the reference idx 22 with the vector register idx of the selected vector register. When the reference idx 22 is not an initial value, since a vector register idx is already selected, the register selection unit 14A does not select a vector register idx. When there is a plurality of groups of vector registers having the same interval, the register selection unit 14A randomly selects a vector register from the group having a larger interval. This is because it is presumed that there is a possibility that a register may be used in conversion of several instructions by selecting a vector register that has not been used recently.

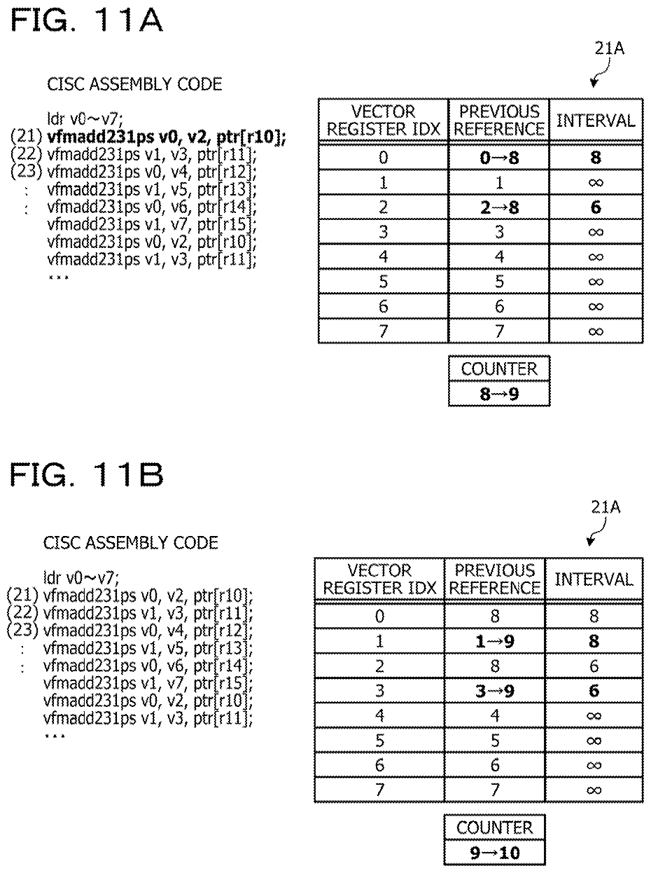

Recording of intervals will be described with reference to FIGS. 11A and 11B. FIGS. 11A and 11B are diagrams describing recording of intervals.

As illustrated in FIG. 11A, the instruction acquisition unit 12 acquires the instruction (21) as an assembly code to be converted from CISC to RISC. The instruction determination unit 13 determines whether the instruction (21) is an instruction with a memory operand. Since the instruction (21) includes the memory operand ptr[r10], it is determined that the instruction (21) is an instruction with a memory operand.

The register selection unit 14A updates the previous reference of the vector register idx corresponding to the vector register used in the instruction (21) with the value of the counter 23. In the instruction (21), the vector registers used in the instruction are v0 and v2. Accordingly, the register selection unit 14A updates the previous reference in the register management table 21A with the value “8” of the counter 23 for the vector register idx “0” corresponding to v0 and the vector register idx “2” corresponding to v2.

Additionally, for each of the vector register idx corresponding to v0 and the vector register idx corresponding to v2, the register selection unit 14A records, as an interval, the difference before and after the update of the previous reference in the register management table 21A. For the interval corresponding to the vector register idx “0”, since the value of previous reference before the update is “0” and the value of previous reference after the update is “8”, “8” is recorded as the difference before and after the update. For the interval corresponding to the vector register idx “2”, since the value of previous reference before the update is “2” and the value of previous reference after the update is “8”, “6” is recorded as the difference before and after the update.

When intervals are not fully recorded in the register management table 21A, the register selection unit 14A uses the register management table 21A and selects a vector register idx by the second selection method until intervals are fully recorded. For example, the register selection unit 14A uses the register management table 21A and selects the vector register indicating the smallest value of previous reference.

After that, the equivalent instruction generation unit 18 generates a RISC instruction equivalent to a CISC instruction for the instruction (21) by using the selected vector register, and then increments the counter 23. The counter 23 is updated from 8 to 9.

Next, as illustrated in FIG. 11B, the instruction acquisition unit 12 acquires the instruction (22) as an assembly code to be converted from CISC to RISC. The instruction determination unit 13 determines whether the instruction (22) is an instruction with a memory operand. Since the instruction (22) includes the memory operand ptr[r11], it is determined that the instruction (22) is an instruction with a memory operand.

The register selection unit 14A updates the previous reference of the vector register idx corresponding to the vector register used in the instruction (22) with the value of the counter 23. In the instruction (22), the vector registers used in the instruction are v1 and v3. Accordingly, the register selection unit 14A updates the previous reference in the register management table 21A with the value “9” of the counter 23 for the vector register idx “1” corresponding to v1 and the vector register idx “3” corresponding to v3.

Additionally, for each of the vector register idx corresponding to v1 and the vector register idx corresponding to v3, the register selection unit 14A records, as an interval, the difference before and after the update of the previous reference in the register management table 21A. For the interval corresponding to the vector register idx “1”, since the value of previous reference before the update is “1” and the value of previous reference after the update is “9”, “8” is recorded as the difference before and after the update. For the interval corresponding to the vector register idx “3”, since the value of previous reference before the update is “3” and the value of previous reference after the update is “9”, “6” is recorded as the difference before and after the update.

When intervals are not fully recorded in the register management table 21A, the register selection unit 14A uses the register management table 21A and selects a vector register idx by the second selection method until intervals are fully recorded. For example, the register selection unit 14A uses the register management table 21A and selects the vector register indicating the smallest value of previous reference.

After that, the equivalent instruction generation unit 18 generates a RISC instruction equivalent to a CISC instruction for the instruction (22) by using the selected vector register, and then increments the counter 23. The counter 23 is updated from 9 to 10.

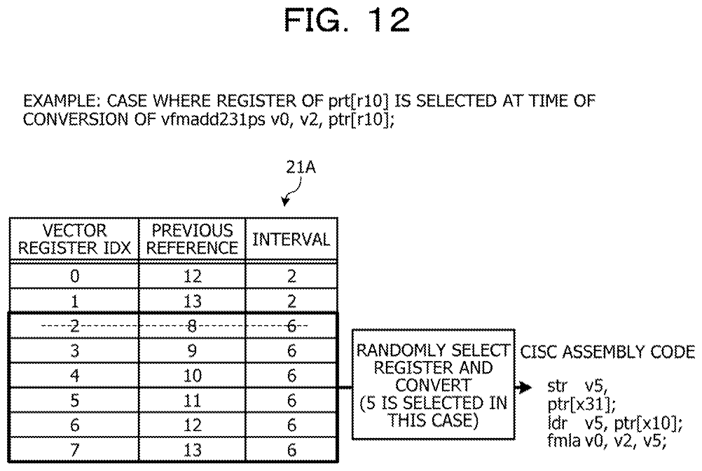

Register selection according to Embodiment 2 will be described with reference to FIG. 12. FIG. 12 is a diagram describing register selection according to Embodiment 2.

As illustrated in FIG. 12, description will be given for a case in which a register for ptr[r10] is selected at the time of conversion from CISC to RISC when a CISC assembly code is “vfmadd231ps v0, v2, ptr[r10];”. ptr[r10] is a memory operand. In the register management table 21A illustrated in FIG. 12, the same interval of “6” is recorded for the vector register idxes 2 to 7.

Under such a situation, since intervals are fully recorded in the register management table 21A, the register selection unit 14A uses the register management table 21A and selects a vector register idx by the first selection method. For example, the register selection unit 14A excludes the vector register used in an instruction from a group of vector registers having the same interval, and randomly selects a vector register. The group of vector registers having the same interval “6” includes “2” to “7” as vector register idxes. The vector register idxes of the vector registers used in the instruction are “0” and “2”. Accordingly, the register selection unit 14A excludes the vector register idx “2” used in the instruction from the vector register idxes “2” to “7”, and randomly selects the vector register idx “5”. The register selection unit 14A updates the reference idx 22 with the value “5” of the selected vector register idx.

The data saving unit 15 generates a store instruction for saving the data stored in the vector register of the selected vector register idx “5” as follows. str v5, ptr[x31];

The data reading unit 16 generates a load instruction for reading data to be memory-accessed into the vector register indicated by the vector register idx “5” stored in the reference idx 22 as follows. Idr v5 ptr[x10];

The equivalent instruction generation unit 18 generates a RISC assembly code equivalent to the CISC assembly code as follows. fmla v0, v2, v5

Accordingly, when all vector registers are used in the group of CISC instructions with a memory operand and the vector registers used in the instructions are used in ascending order, the information processing apparatus 1 may stochastically reduce the number of times of load and store of the following CISC instructions by using the first selection method. Assumed that, under the same situation, the register selection unit 14A uses the second selection method. The register selection unit 14A selects the vector register idx “3” having the smallest value of previous reference. When the vector registers used in the instructions are used in ascending order in the group of CISC instructions with a memory operand, since v3 is used in the next instruction, the register selection unit 14A selects the vector register for memory operand in the instruction. For this reason, load and store instructions are generated. For example, when the second selection method is used, it is difficult for the information processing apparatus 1 to reduce the number of times of load and store of the following CISC instructions.

[Flowchart of Conversion Processing]

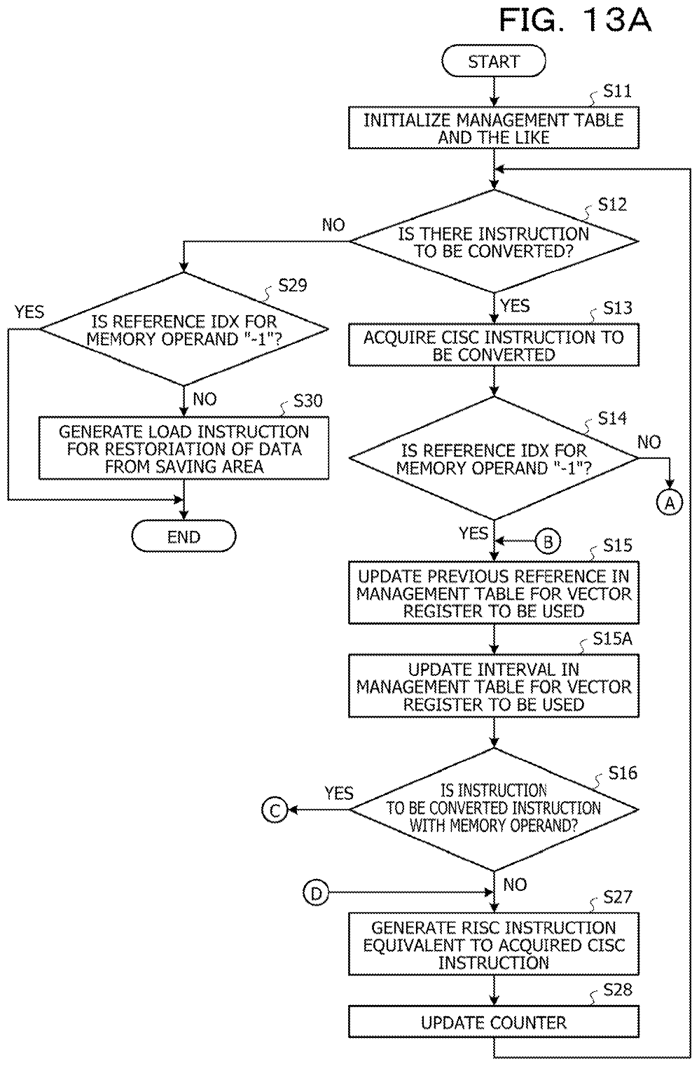

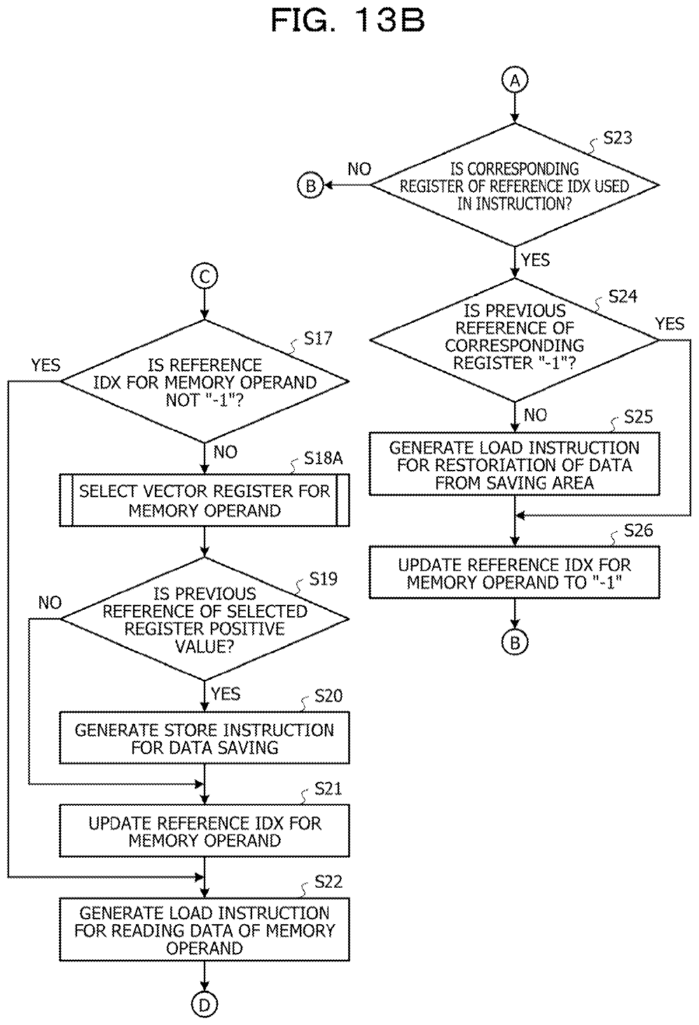

FIGS. 13A and 13B are a diagram illustrating an example of a flowchart of conversion processing according to Embodiment 2. In the flowchart of the conversion processing according to Embodiment 2, same flow and operation as those in the flowchart of the conversion processing according to Embodiment 1 illustrated in FIGS. 7A and 7B are given the same reference signs.

As illustrated in FIGS. 13A and 13B, the information processing apparatus 1 initializes the register management table 21A and the like (step S11). For example, the initialization unit 11 sets an available vector register idx in the register management table 21A, and sets “−1” as an initial value for the previous reference corresponding to the vector register idx. Additionally, the initialization unit 11 sets infinity as an initial value of interval in the register management table 21A. The initialization unit 11 sets “−1” as an initial value for the reference idx 22. The initialization unit 11 sets “0” as an initial value for the counter 23.

The information processing apparatus 1 determines whether there is an instruction to be converted from CISC to RISC (step S12). When it is determined that there is an instruction to be converted (step S12; Yes), the information processing apparatus 1 acquires a CISC instruction to be converted (step S13). The information processing apparatus 1 determines whether the reference idx 22 for memory operand is “−1” indicating an initial value (step S14).

When it is determined that the reference idx 22 for memory operand is “−1” (step S14; Yes), the information processing apparatus 1 updates the previous reference in the register management table 21A for the vector register to be used for conversion (step S15). For example, the register selection unit 14A updates the previous reference in the register management table 21A with the value of the counter 23 for the vector register idx corresponding to the vector register to be used for conversion. Additionally, for the same vector register, the information processing apparatus 1 records, as an interval, the difference before and after the update of the previous reference in the register management table 21A (step S15A).

The information processing apparatus 1 determines whether the CISC instruction to be converted is an instruction with a memory operand (step S16). When it is determined that the CISC instruction to be converted is not an instruction with a memory operand (step S16; No), the information processing apparatus 1 proceeds to step S27 to convert the CISC instruction as it is.

On the other hand, when it is determined that the CISC instruction to be converted is an instruction with a memory operand (step S16; Yes), the information processing apparatus 1 determines whether the reference idx 22 for memory operand is not “−1” indicating an initial value (step S17). When it is determined that the reference idx 22 for memory operand is not “−1” (step S17; Yes), the information processing apparatus 1 does not save the data of the vector register indicated by the reference idx 22, and proceeds to step S22.

On the other hand, when it is determined that the reference idx 22 for memory operand is “−1” (step S17; No), the information processing apparatus 1 selects a vector register for memory operand (step S18A). A flowchart for selecting a vector register will be described later.

The information processing apparatus 1 determines whether the previous reference of the selected vector register is a positive value (step S19). For example, the data saving unit 15 determines whether the value of previous reference in the register management table 21A is a positive value for the selected vector register idx.

When it is determined that the previous reference of the selected vector register is a positive value (step S19; Yes), the information processing apparatus 1 generates a store instruction for data saving for the selected vector register (step S20). For example, when the value of previous reference in the register management table 21 is a positive value, the data saving unit 15 generates a store instruction for saving the data stored in the vector register indicated by the selected vector register idx to the saving area 24. The information processing apparatus 1 proceeds to step S21.

On the other hand, when it is determined that the previous reference of the selected vector register is not a positive value (step S19; No), the information processing apparatus 1 does not save the data of the selected vector register, and proceeds to step S21.

In step S21, the information processing apparatus 1 updates the reference idx 22 for memory operand (step S21). For example, the register selection unit 14 updates the reference idx 22 with the selected vector register idx. The information processing apparatus 1 proceeds to step S22.

In step S22, the information processing apparatus 1 generates a load instruction for reading data of a memory operand (step S22). For example, the data reading unit 16 generates a load instruction for reading data to be memory-accessed into a vector register indicated by a vector register idx stored in the reference idx 22. The information processing apparatus 1 proceeds to step S27 to convert the CISC instruction.

In step S14, when it is determined that the reference idx 22 for memory operand is not “−1” (step S14; No), the information processing apparatus 1 determines whether the corresponding register of the reference idx 22 is used in the instruction (step S23). For example, when the reference idx 22 is not an initial value, the data restoration unit 17 determines whether the corresponding register of a vector register idx stored in the reference idx 22 is used in a CISC instruction to be converted.

When it is determined that the corresponding register of the reference idx 22 is not used in the instruction (step S23; No), the information processing apparatus 1 does not restore data to the vector register indicated by the reference idx 22, and proceeds to step S15.

On the other hand, when it is determined that the corresponding register of the reference idx 22 is used in the instruction (step S23; Yes), the information processing apparatus 1 determines whether the previous reference of the corresponding register is “−1”, which is an initial value (step S24). For example, the data restoration unit 17 determines whether the value of previous reference in the register management table 21A is an initial value for a vector register idx stored in the reference idx 22.

When it is determined that the previous reference of the corresponding register is “−1” indicating an initial value (step S24; Yes), the information processing apparatus 1 proceeds to step S26 to update the previous reference of the vector register to be used. The information processing apparatus 1 does not restore data to the vector register indicated by the reference idx 22.

On the other hand, when it is determined that the previous reference of the corresponding register is not “−1” indicating an initial value (step S24; No), the information processing apparatus 1 generates a load instruction for restoration of data from the saving area 24 (step S25). For example, when the value of previous reference in the register management table 21A is a positive value for a vector register idx stored in the reference idx 22, the data restoration unit 17 generates a load instruction for restoring data to the corresponding register. The information processing apparatus 1 proceeds to step S26.

In step S26, the information processing apparatus 1 updates the reference idx 22 for memory operand to “−1” indicating an initial value (step S26). The information processing apparatus 1 proceeds to step S15 to update the previous reference of the vector register to be used.

In step S27, the information processing apparatus 1 generates a RISC instruction equivalent to the acquired CISC instruction (step S27). For example, when a load instruction for reading data into a vector register to be used for conversion of a memory operand is generated, the equivalent instruction generation unit 18 generates a RISC instruction equivalent to a CISC instruction using the vector register.

The information processing apparatus 1 updates the counter 23 (step S28). For example, the equivalent instruction generation unit 18 increments the counter 23 each time conversion of a CISC instruction is performed. The information processing apparatus 1 proceeds to step S12 to acquire the next instruction to be converted.

When it is determined in step S12 that there is no instruction to be converted (step S12; No), the information processing apparatus 1 determines whether the reference idx 22 for memory operand is “−1” indicating an initial value (step S29). When it is determined that the reference idx 22 for memory operand is “−1” (step S29; Yes), the information processing apparatus 1 ends the conversion processing.

On the other hand, when it is determined that the reference idx 22 for memory operand is not “−1” (step S29; No), the information processing apparatus 1 generates a load instruction for restoration of data from the saving area 24 (step S30). For example, the data restoration unit 17 generates a load instruction for restoring data to the corresponding register for a vector register idx stored in the reference idx 22. The information processing apparatus 1 ends the conversion processing.

[Flowchart of Register Selection Processing]

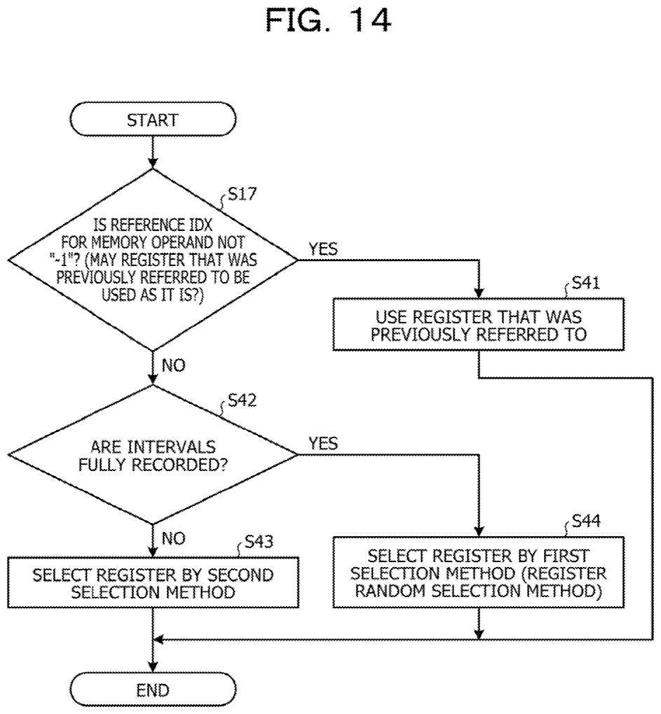

FIG. 14 is a diagram illustrating an example of a flowchart of register selection processing according to Embodiment 2. As illustrated in FIG. 14, the register selection unit 14A determines whether the reference idx 22 for memory operand is not “−1” indicating an initial value (step S17). For example, the register selection unit 14A determines whether the register that was previously referred to may be used as it is.

When it is determined that the reference idx 22 for memory operand is not “−1” (step S17; Yes), the register selection unit 14A uses the register that was previously referred to (step S41). For example, the register selection unit 14A selects the vector register indicated by the vector register idx set for the reference idx 22. The register selection unit 14A ends the register selection processing.

When it is determined that the reference idx 22 for memory operand is “−1” (step S17; No), the register selection unit 14A determines whether intervals are fully recorded in the register management table 21A (step S42). When it is determined that intervals are fully not recorded (step S42; No), the register selection unit 14A selects a vector register by the second selection method (step S43). For example, the register selection unit 14A uses the register management table 21A and selects the vector register indicating the smallest value of previous reference. The register selection unit 14A ends the register selection processing.

On the other hand, when it is determined that intervals are fully recorded (step S42; Yes), the register selection unit 14A selects a vector register by the first selection method (step S44). For example, the register selection unit 14A excludes the vector register used in an instruction from a group of vector registers having the same interval, and randomly selects a vector register. The register selection unit 14A ends the register selection processing.

[Effect of Conversion Processing]

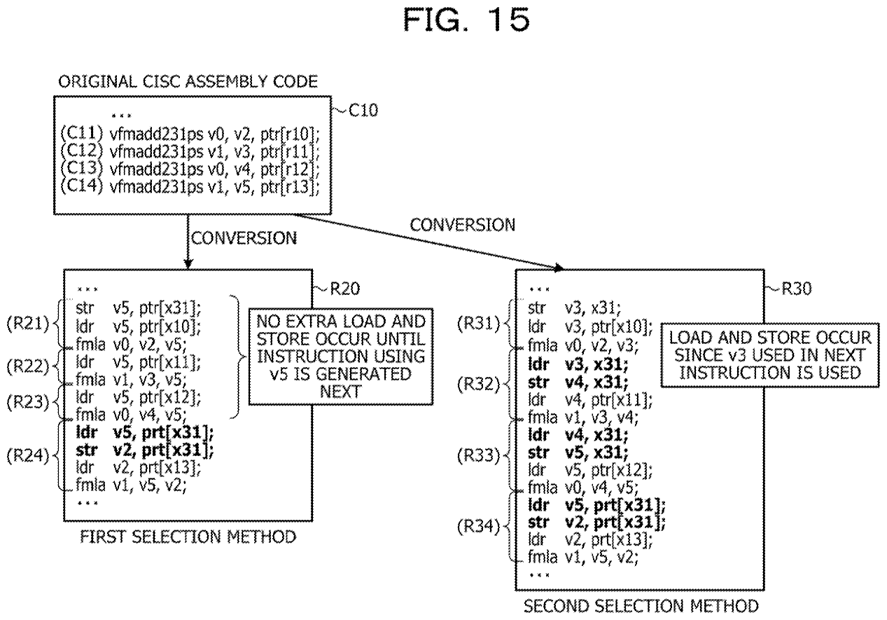

An example of an effect of the conversion processing according to Embodiment 2 will be described with reference to FIG. 15. FIG. 15 is a diagram describing an effect of the conversion processing according to Embodiment 2. As illustrated in FIG. 15, an original CISC assembly code C10 is represented. Four instructions of (C11), (C12), (C13), and (C14) are written in the CISC assembly code, and each instruction is an instruction with a memory operand. All vector registers are used in the group of CISC instructions with a memory operand, and the vector registers are used in ascending order from v2.

When the original CISC assembly code C10 is converted by using the second selection method, the conversion result is an assembly code denoted by reference sign R30. For example, the CISC instruction (C11) is converted into a RISC instruction (R31). The CISC instruction (C12) is converted into a RISC instruction (R32). The CISC instruction (C13) is converted into a RISC instruction (R33). The CISC instruction (C14) is converted into a RISC instruction (R34). The following processing is performed in the conversion processing using the second selection method.

In the conversion processing (R31) of the instruction (C11), vector register v3 having the smallest value of previous reference is selected as the vector register for memory operand. In the conversion processing (R32) of the next instruction (C12), since vector register v3 is used in the instruction (C12), vector register v4 having the smallest value of previous reference is newly selected as the vector register for memory operand. For this reason, restoration of data (load) to v3 and saving of data (store) to v4 occur. Also in the conversion processing of the subsequent instructions (C13) and (C14), data restoration (load) and data saving (store) occur in a similar manner.

By contrast, when the original CISC assembly code C10 is converted by using the first selection method, the conversion result is an assembly code denoted by reference sign R20. For example, the CISC instruction (C11) is converted into a RISC instruction (R21). The CISC instruction (C12) is converted into a RISC instruction (R22). The CISC instruction (C13) is converted into a RISC instruction (R23). The CISC instruction (C14) is converted into a RISC instruction (R24). The following processing is performed in the conversion processing using the first selection method.

In the conversion processing (R21) of the instruction (C11), the vector register used in the instruction is excluded from a group of vector registers having the same interval, and vector register v5 is randomly selected as the vector register for memory operand. In the conversion processing (R22) of the next instruction (C12), since vector register v5 is not used in the instruction (C12), no extra data restoration (load) and data saving (store) occur. For example, data restoration (load) and data saving (store) do not occur until an instruction using vector register v5 is generated next.

As described above, in conversion processing using the first selection method, since a vector register for memory operand is randomly selected, the number of data saving instructions and data restoration instructions may be stochastically reduced.

### Effect of Embodiment 2

As described above, in the above Embodiment 2, the information processing apparatus 1 increments the counter 23 each time a CISC instruction is converted into a RISC instruction. When converting a CISC instruction with a memory operand into a RISC instruction, the information processing apparatus 1 updates the conversion timing of the register used for the conversion with the value of the counter 23. The information processing apparatus 1 records the difference before and after the update of the conversion timing as an interval. When a CISC instruction before conversion includes a use register number storing a register number to be used for conversion of a memory operand, the information processing apparatus 1 restores data for the register indicated by the use register number, uses the register management table 21A in which a register number, conversion timing, and an interval are associated with each other and randomly selects a register number from among the register numbers having the same interval condition, and updates the use register number with the selected register number. The information processing apparatus 1 saves the data for the register indicated by the updated use register number, and uses the register indicated by the updated use register number and generates an instruction for reading data of a memory operand. When a CISC instruction before conversion does not include the use register number, the information processing apparatus 1 uses the register indicated by the use register number and generates an instruction for reading data of a memory operand without restoring and saving data for the register indicated by the use register number. The information processing apparatus 1 generates a RISC instruction equivalent to a CISC instruction. Accordingly, even in such a case that register numbers are generated in ascending order in a group of CISC instructions before conversion, the information processing apparatus 1 may reduce the number of data restoration (load) instructions and data saving (store) instructions in the registers by randomly selecting a register to be used for conversion of an operand from among the registers having the same interval condition. As a result, the information processing apparatus 1 may improve the execution speed of the processing of converting a CISC instruction into a RISC instruction.

In the above Embodiment 2, when intervals associated with respective register numbers are fully set in the register management table 21A, the information processing apparatus 1 selects a register number by the first selection method of excluding the use register number and randomly selecting a register number from among the register numbers having the same interval condition. Accordingly, the information processing apparatus 1 may randomly select a register to be used for conversion of an operand by using the intervals associated with the register numbers.

In the above Embodiment 2, when a plurality of intervals with different values is stored in the register management table 21A, the information processing apparatus 1 selects a register number from among the register numbers having a larger value of interval. Accordingly, the information processing apparatus 1 may efficiently select a register number. For example, it is presumed that there is a possibility that a register may be used in conversion of several instructions by selecting a register number of a register that has not been used recently, and the information processing apparatus 1 may efficiently select a register number.

In the above Embodiment 2, when intervals associated with respective register numbers are not fully set in the register management table 21A, the information processing apparatus 1 selects a register number by the second selection method of selecting a register number of the oldest conversion timing that is different from the use register number. Accordingly, even when intervals are not fully set for the register numbers, by using the register management table 21A, the information processing apparatus 1 may reduce the number of instructions for restoring (load) and saving (store) data of the register to be used for reading data of a memory operand.

It has been described that, in the conversion processing according to Embodiment 2, when the information processing apparatus 1 converts a CISC instruction with a memory operand into a RISC instruction, a vector register for memory operand is selected as follows. For example, it has been described that the information processing apparatus 1 applies the first selection method of randomly selecting a vector register for memory operand when all vector registers are used in a group of CISC instructions before conversion and instructions designating the vector registers in ascending order continue to be generated. However, there is a case in which although instructions designating vector registers in ascending order are generated in a group of CISC instructions, instructions designating vector registers in descending order are generated in the middle of the instructions. In such a case, there is a case in which the efficiency of selecting a vector register for memory operand decreases if a vector register for memory operand continues to be randomly selected.

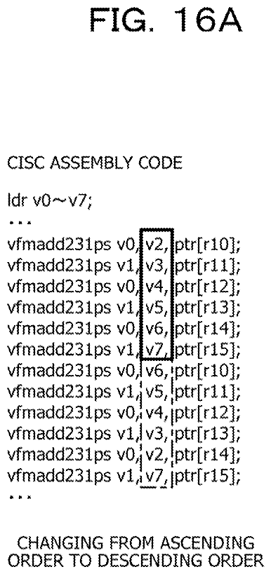

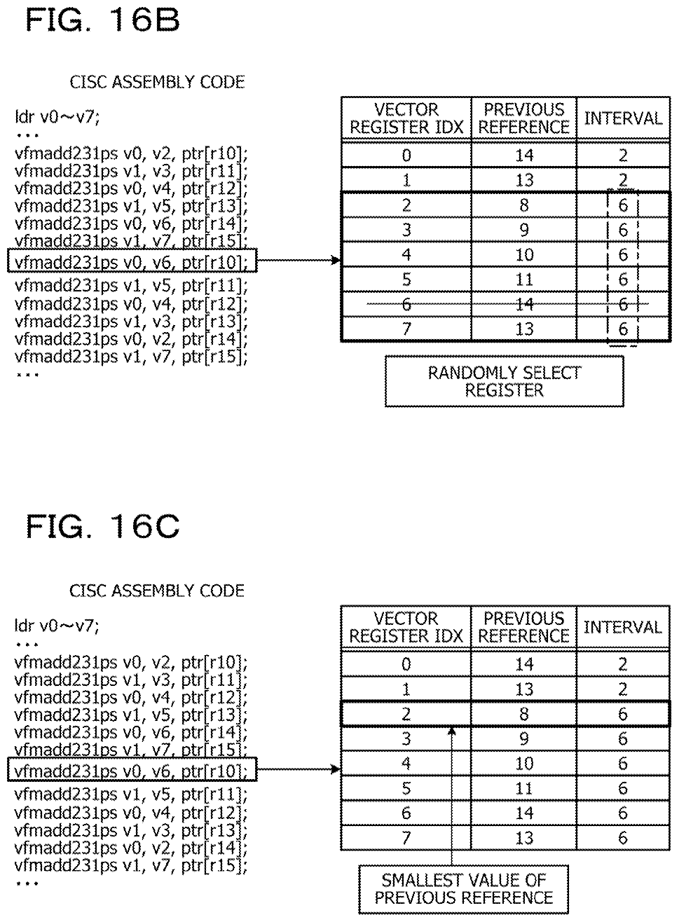

Description will be given for a case in which the efficiency of selecting a vector register for memory operand decreases. FIGS. 16A to 16C are diagrams describing a pattern in which the efficiency decreases. In FIGS. 16A to 16C, v0 to v8 are all vector registers. As illustrated in FIG. 16A, in a CISC assembly code, instructions designating vector registers in ascending order of v2 to v7 are generated in the group of CISC instructions, and then instructions designating vector registers in descending order of v6 to v2 are generated.

In such a case, as illustrated in FIG. 16B, since intervals are fully recorded in the register management table 21A, the information processing apparatus 1 uses the register management table 21A and selects a vector register by the first selection method. For example, the information processing apparatus 1 excludes the vector register used in an instruction from a group of vector registers having the same interval, and randomly selects a vector register. When a vector register is newly selected at the timing at which the vector registers are in descending order in the group of CISC instructions (from v7 to v6), the information processing apparatus 1 selects a vector register as follows. For example, the information processing apparatus 1 excludes v6 used in the instruction from the group of vector registers v2 to v7 having the same interval of “6”, and randomly selects a vector register.

Assume that, in such a case, as illustrated in FIG. 16C, a vector register is selected by the second selection method at the timing at which the vector registers are in descending order in the group of CISC instructions. For example, the vector register with the smallest value of previous reference is selected. v2 indicating the smallest value of previous reference is selected. Since the number of instructions for restoration (load) and saving (store) of data may be reduced until vector register v2 is designated in the group of CISC instructions, in such a case, the possibility that an appropriate vector register may be selected is increased by applying the second selection method.

Accordingly, the inventor considered that a function of selecting a vector register by using the first selection method and the second selection method is desired when intervals are fully recorded in the register management table 21A.

Accordingly, in Embodiment 3 described below, description will be given for an information processing apparatus 1 that stochastically selects a vector register selection method from the first selection method and the second selection method when intervals are fully recorded in the register management table 21A.

### Embodiment 3

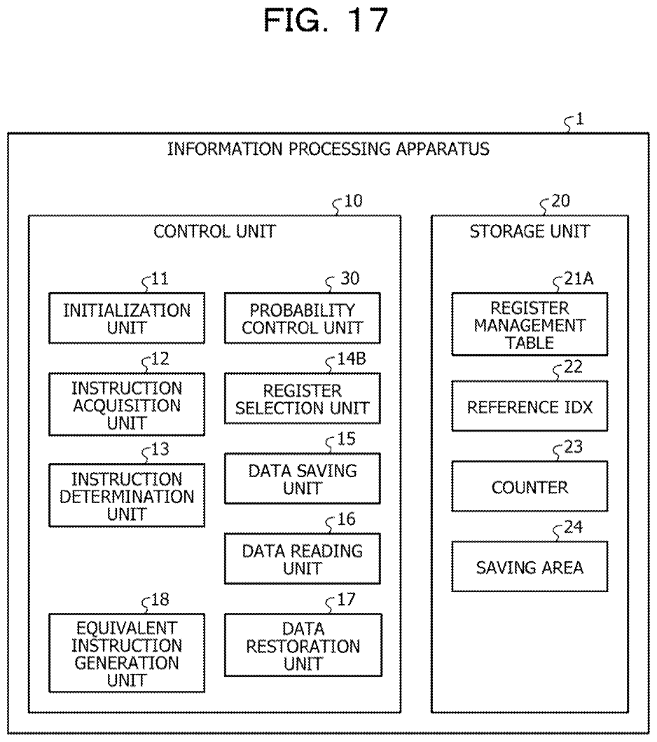

FIG. 17 is a block diagram illustrating an example of a functional configuration of the information processing apparatus according to Embodiment 3. When the intervals of all vector registers are recorded, the information processing apparatus 1 according to Embodiment 3 stochastically selects a register selection method from the first selection method and the second selection method.

In the functional configuration of the information processing apparatus 1 according to Embodiment 3, same elements as those of the information processing apparatus 1 illustrated in FIG. 9 are given the same reference signs, and description for the overlapping elements and operation will be omitted. Embodiment 2 and Embodiment 3 are different in that the register selection unit 14A is changed to a register selection unit 14B. Embodiment 1 and Embodiment 2 are different in that a probability control unit 30 is added.

Based on the register management table 21A and the probability of selecting the first selection method, the register selection unit 14B selects a vector register to be used for conversion of a memory operand. For example, when a CISC instruction with a memory operand is converted into a RISC instruction, the register selection unit 14B acquires a vector register idx corresponding to the vector register used in the instruction. The register selection unit 14A updates the previous reference in the register management table 21A with the value of the counter 23 for the acquired vector register idx. Additionally, for the same vector register idx, the register selection unit 14B records, as an interval, the difference before and after the update of the previous reference in the register management table 21A.

When the reference idx 22 storing a vector register idx to be used for conversion of a memory operand is an initial value, the register selection unit 14B selects a vector register idx as follows. When intervals are not fully recorded in the register management table 21A, the register selection unit 14B uses the register management table 21A and selects a vector register idx by the second selection method. For example, the register selection unit 14B uses the register management table 21A and selects the vector register indicating the smallest value of previous reference. When intervals are fully recorded in the register management table 21A, the register selection unit 14B selects the first selection method or the second selection method based on the probability of selecting the first selection method, and selects a vector register idx by using the selected selection method. As an example, when a probability ε of selecting the first selection method is larger than a predetermined value, the register selection unit 14B selects a vector register idx by using the first selection method. On the other hand, when the probability ε of selecting the first selection method is equal to or smaller than the predetermined value, the register selection unit 14B selects a vector register idx by using the second selection method. For example, the predetermined value is 0.5, but the predetermined value is not limited to this.

The probability control unit 30 controls the probability of selecting the first selection method.

For example, when the reference idx 22 storing a vector register idx to be used for conversion of a memory operand is an initial value and a vector register is selected by using the first selection method in the immediately preceding instruction, the probability control unit 30 decreases the probability by a. For example, when the vector register that was previously referred to may not be used as it is and a vector register is selected by the first selection method in the immediately preceding instruction, the probability control unit 30 determines that a vector register has not been efficiently selected by the first selection method, and decreases the probability. When the reference idx 22 storing a vector register idx to be used for conversion of a memory operand is an initial value and a vector register is selected by using the second selection method in the immediately preceding instruction, the probability control unit 30 increases the probability by a. For example, when the vector register that was previously referred to may not be used as it is and a vector register is selected by the second selection method in the immediately preceding instruction, the probability control unit 30 determines that it is not true that a vector register has not been efficiently selected by the first selection method, and increases the probability.

When the reference idx 22 storing a vector register idx to be used for conversion of a memory operand is not an initial value and a vector register is selected by using the first selection method in the immediately preceding instruction, the probability control unit 30 increases the probability by a. For example, when the vector register that was previously referred to may be used as it is and a vector register is selected by the first selection method in the immediately preceding instruction, the probability control unit 30 determines that a vector register has been efficiently selected by the first selection method, and increases the probability. When the reference idx 22 storing a vector register idx to be used for conversion of a memory operand is not an initial value and a vector register is selected by using the second selection method in the immediately preceding instruction, the probability control unit 30 decreases the probability by a. For example, when the vector register that was previously referred to may be used as it is and a vector register is selected by the second selection method in the immediately preceding instruction, the probability control unit 30 determines that it is not true that a vector register has been efficiently selected by the first selection method, and decreases the probability.

The probability ε of selecting the first selection method is a value larger than 0 and smaller than 1. An initial value of the probability ε is 0.5. By setting an initial value of the probability ε to 0.5, each of the first selection method and the second selection method is selected with a probability of 50%. α is an update value. For example, α is 0.1, but a is not limited to this.

[Flowchart of Register Selection Processing]

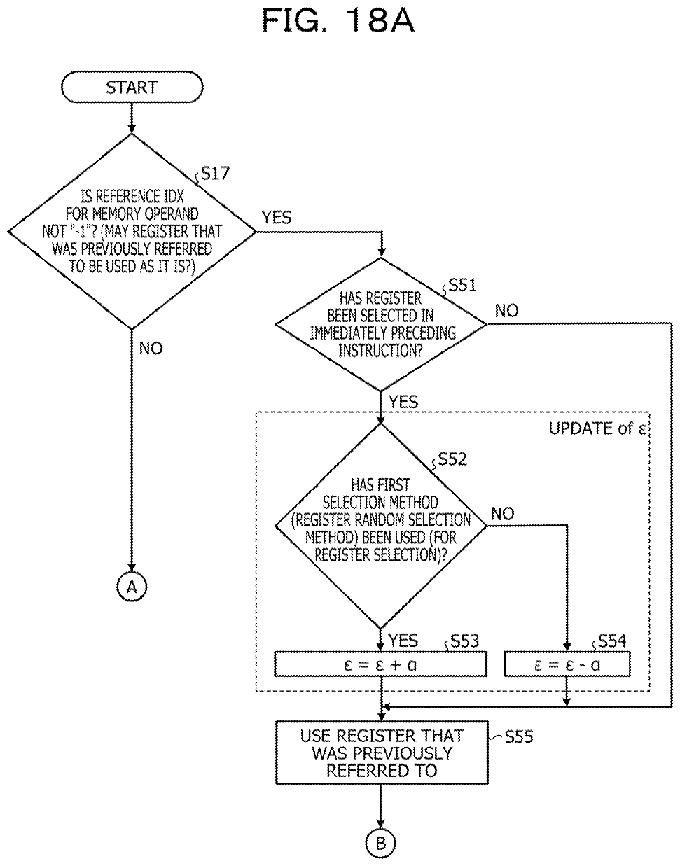

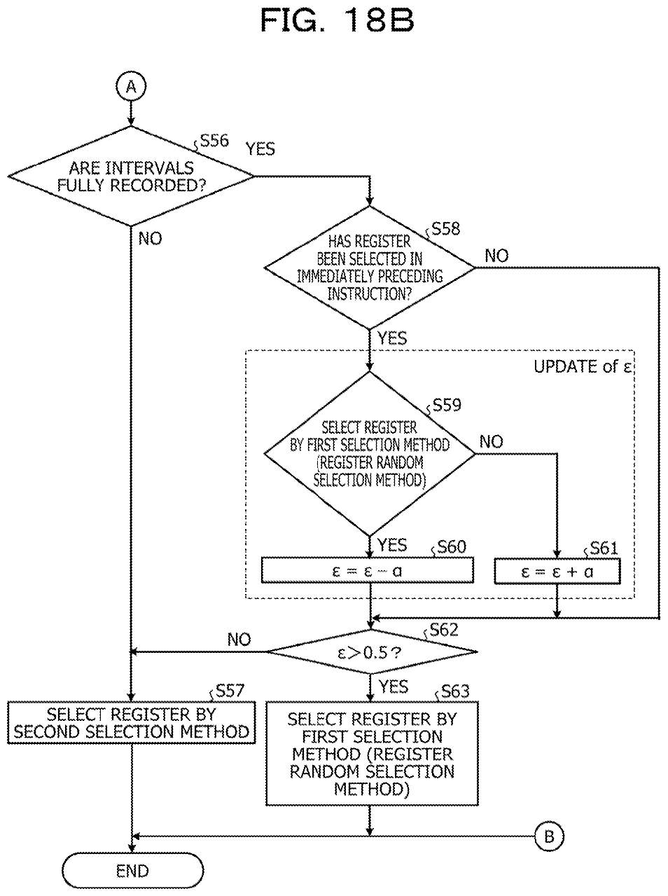

FIGS. 18A and 18B are a diagram illustrating an example of a flowchart of register selection processing according to Embodiment 3. A flowchart of conversion processing according to Embodiment 3 is similar to the flowchart in FIGS. 13A and 13B, and thus description thereof will be omitted. The probability ε used in the flowchart is the probability of selecting the first selection method.

As illustrated in FIGS. 18A and 18B, the register selection unit 14B determines whether the reference idx 22 for memory operand is not “−1” indicating an initial value (step S17). For example, the register selection unit 14B determines whether the register that was previously referred to may be used as it is.

When it is determined that the reference idx 22 for memory operand is not “−1” (step S17; Yes), the probability control unit 30 determines whether a register has been selected in the immediately preceding instruction (step S51). When it is determined that a register has not been selected in the immediately preceding instruction (step S51; No), the probability control unit 30 proceeds to step S55 without changing the probability.

On the other hand, when it is determined that a register has been selected in the immediately preceding instruction (step S51; Yes), the probability control unit 30 determines whether the register random selection method (first selection method) has been used for the selection of the register (step S52). When it is determined that the register random selection method (first selection method) has been used (step S52; Yes), the probability control unit 30 increases the probability ε by a (step S53). This is because it is presumed that a vector register has been efficiently selected by the first selection method. The probability control unit 30 proceeds to step S55.

On the other hand, when it is determined that the register random selection method (first selection method) has not been used (step S52; No), the probability control unit 30 decreases the probability ε by a (step S54). This is because it is presumed that it is not true that a vector register has been efficiently selected by the first selection method. The probability control unit 30 proceeds to step S55.

In step S55, the register selection unit 14B uses the register that was previously referred to (step S55). For example, the register selection unit 14B selects the register that was previously referred to as it is. The register selection unit 14B ends the register selection processing.

In step S17, when it is determined that the reference idx 22 for memory operand is “−1” (step S17; No), the probability control unit 30 determines whether intervals are fully recorded in the register management table 21A (step S56). When it is determined that intervals are not fully recorded (step S56; No), the probability control unit 30 proceeds to step S57 without changing the probability.

On the other hand, when it is determined that intervals are fully recorded (step S56; Yes), the probability control unit 30 determines whether a register has been selected in the immediately preceding instruction (step S58). When it is determined that a register has not been selected in the immediately preceding instruction (step S58; No), the probability control unit 30 proceeds to step S62 without changing the probability.

On the other hand, when it is determined that a register has been selected in the immediately preceding instruction (Step S58; Yes), the probability control unit 30 determines whether the register random selection method (first selection method) has been used for the selection of the register (Step S59). When it is determined that the register random selection method (first selection method) has been used (step S59; Yes), the probability control unit 30 decreases the probability ε by a (step S60). This is because it is presumed that a vector register has not been efficiently selected by the first selection method. The probability control unit 30 proceeds to step S62.

On the other hand, when it is determined that the register random selection method (first selection method) has not been used (step S59; No), the probability control unit 30 increases the probability ε by a (step S61). This is because it is presumed that it is not true that a vector register has not been efficiently selected by the first selection method. The probability control unit 30 proceeds to step S62.

In step S62, the register selection unit 14B determines whether the probability ε is larger than 0.5 (step S62). When it is determined that the probability ε is equal to or smaller than 0.5 (step S62; No), the register selection unit 14B proceeds to step S57.

In step S57, the register selection unit 14B selects a register by the second selection method. The register selection unit 14B ends the register selection processing.

On the other hand, when it is determined that the probability ε is larger than 0.5 (step S62; Yes), the register selection unit 14B selects a register by the first selection method (register random selection method) (step S63). The register selection unit 14B ends the register selection processing.

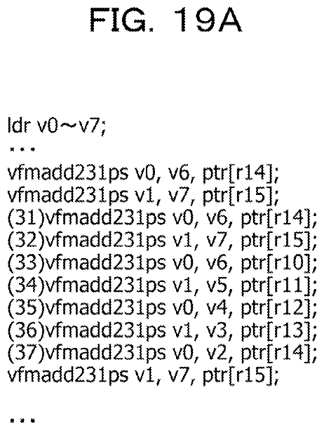

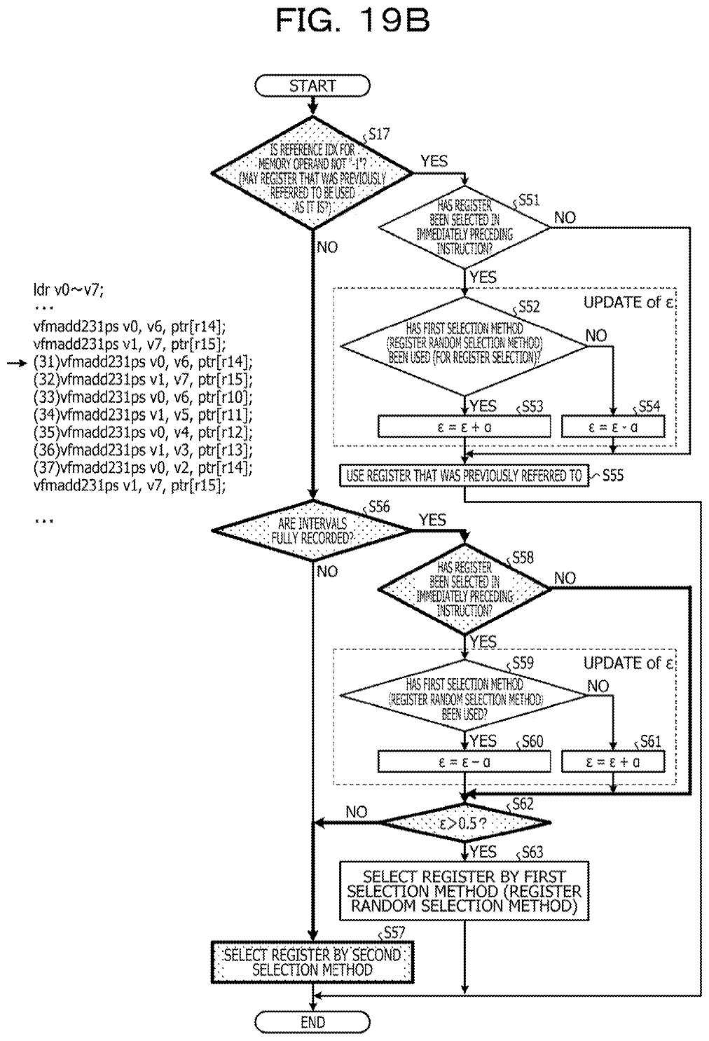

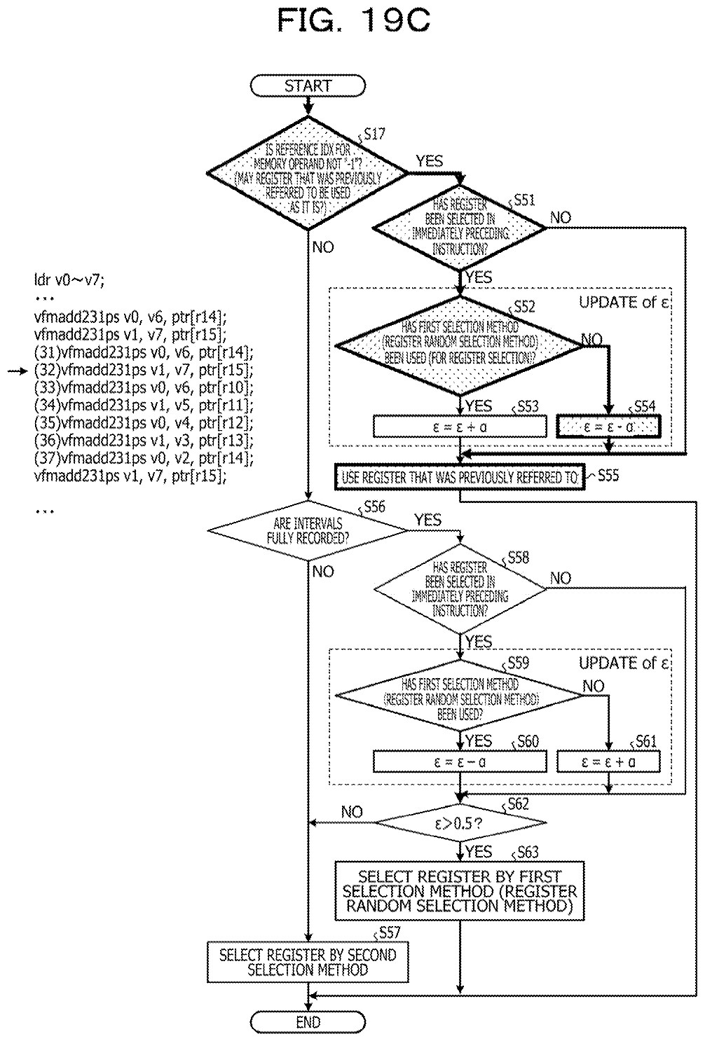

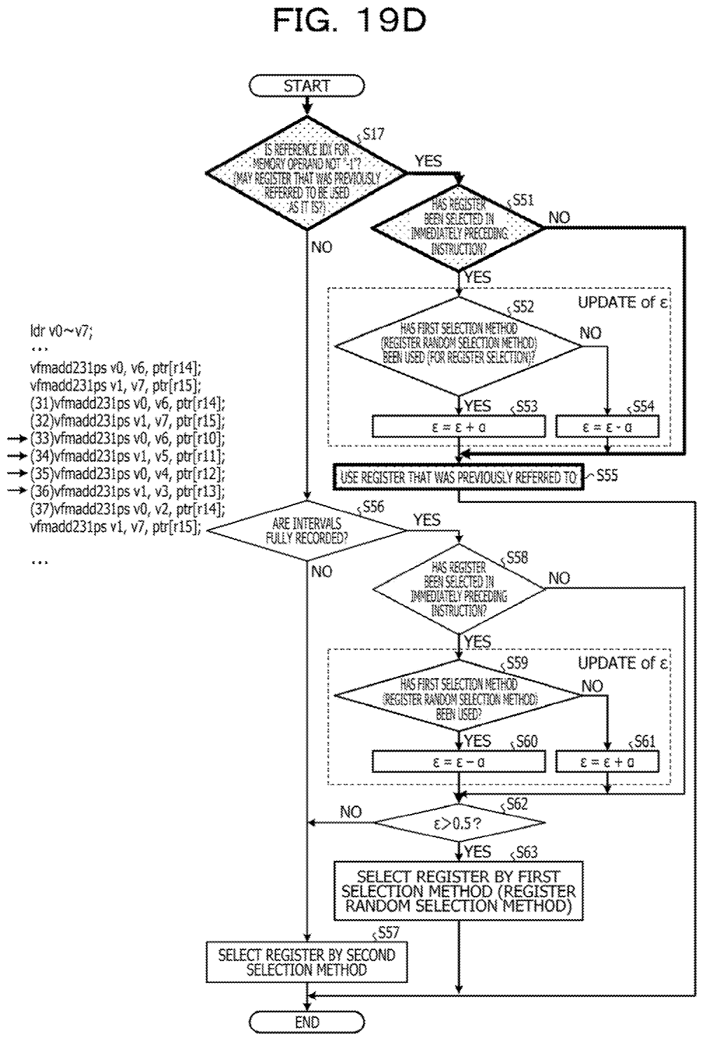

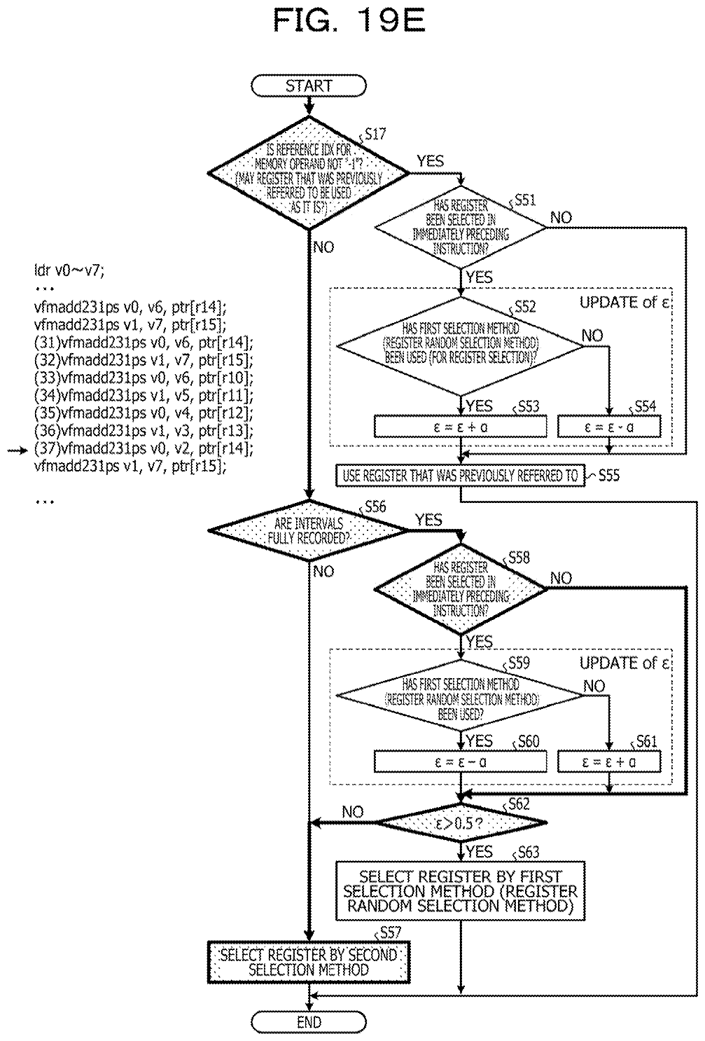

An example of the register selection processing according to Embodiment 3 will be described with reference to FIGS. 19A to 19E. FIGS. 19A to 19E are diagrams illustrating an example of the register selection processing according to Embodiment 3. FIG. 19A illustrates a case in which a CISC instruction is converted into a RISC instruction, for a group of CISC instructions in which although instructions designating vector registers in ascending order of v6, v7 are generated, instructions designating vector registers in descending order of v6, v5, . . . are generated in the middle of the instructions. The probability ε is 0.4.

FIG. 19B illustrates a case in which a CISC instruction (31) among the group of CISC instructions is converted. As a premise, in this case, the register that was previously referred to may not be used as it is. In this case, intervals are fully recorded. In this case, a register has not been selected in the immediately preceding instruction.

In the case of such a premise, since the register that was previously referred to may not be used as it is, the register selection unit 14B determines that the reference idx 22 for memory operand is “−1”. Since intervals are fully recorded, the probability control unit 30 determines whether a register has been selected in the immediately preceding instruction. Since a register has not been selected in the immediately preceding instruction, the register selection unit 14B determines whether the probability ε is larger than 0.5. Since the probability ε is 0.4, the register selection unit 14B selects a register by the second selection method. For example, register v2 is selected by the second selection method. After that, the equivalent instruction generation unit 18 uses v2 as a register into which memory operand ptr[r14] is loaded, and converts the CISC instruction (31) into a RISC instruction.

Next, FIG. 19C illustrates a case in which a CISC instruction (32) among the group of CISC instructions is converted. In this case, since register v2 that was previously referred to is not designated in the CISC instruction (32), register v2 that was previously referred to may be used as it is. In this case, intervals are fully recorded. In this case, a register has been selected in the immediately preceding instruction by the second selection method.

In such a case, since the register that was previously referred to may be used as it is and a register has been selected in the immediately preceding instruction by the second selection method, the probability control unit decreases the probability ε by a. This is because it is presumed that a vector register has been efficiently selected by the second selection method and that it is not true that a vector register has been efficiently selected by the first selection method. It is assumed that the probability ε has decreased to 0.3. The register selection unit 14B uses the register that was previously referred to. Register v2 is used. Accordingly, after that, the equivalent instruction generation unit 18 uses v2 as a register into which memory operand ptr[r15] is loaded, and converts the CISC instruction (32) into a RISC instruction.

Next, FIG. 19D illustrates a case in which a CISC instruction (33) among the group of CISC instructions is converted. In this case, since register v2 that was previously referred to is not designated in the CISC instruction (33), register v2 that was previously referred to may be used as it is. In this case, intervals are fully recorded. In this case, a register has not been selected in the immediately preceding instruction.

In such a case, since the register that was previously referred to may be used as it is and a register has not been selected in the immediately preceding instruction, the probability control unit 30 does not calculate the probability E. The register selection unit 14B uses the register that was previously referred to. Register v2 is used. Accordingly, after that, the equivalent instruction generation unit 18 uses v2 as a register into which memory operand ptr[r10] is loaded, and converts the CISC instruction (33) into a RISC instruction.

CISC instructions (34) to (36) are processed in the same manner as the CISC instruction (33).

Next, FIG. 19E illustrates a case in which a CISC instruction (37) among the group of CISC instructions is converted. In this case, since register v2 that was previously referred to is designated in the CISC instruction (37), register v2 that was previously referred to may not be used as it is. In this case, intervals are fully recorded. In this case, a register has not been selected in the immediately preceding instruction.

In such a case, since the register that was previously referred to may not be used as it is, the register selection unit 14B determines that the reference idx 22 for memory operand is “−1”. Since intervals are fully recorded, the probability control unit 30 determines whether a register has been selected in the immediately preceding instruction. Since a register has not been selected in the immediately preceding instruction, the register selection unit 14B determines whether the probability E is larger than 0.5. Since the probability E is 0.3, the register selection unit 14B selects a register by the second selection method. After that, the equivalent instruction generation unit 18 uses the register selected as a register into which memory operand ptr[r14] is loaded, and converts the CISC instruction (37) into a RISC instruction.

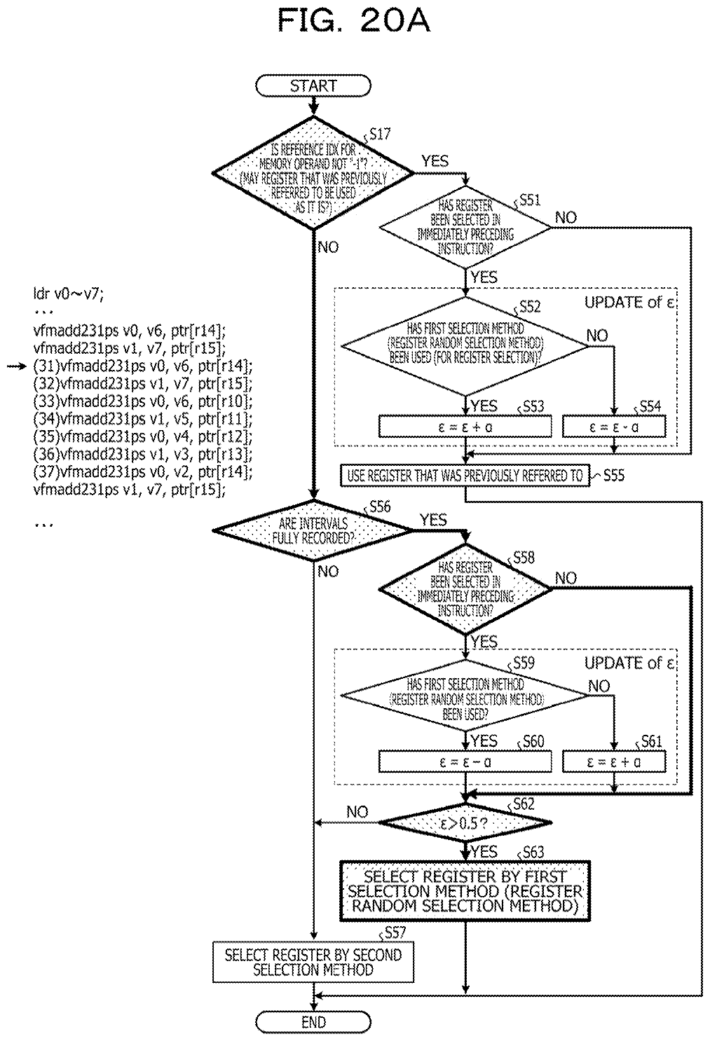

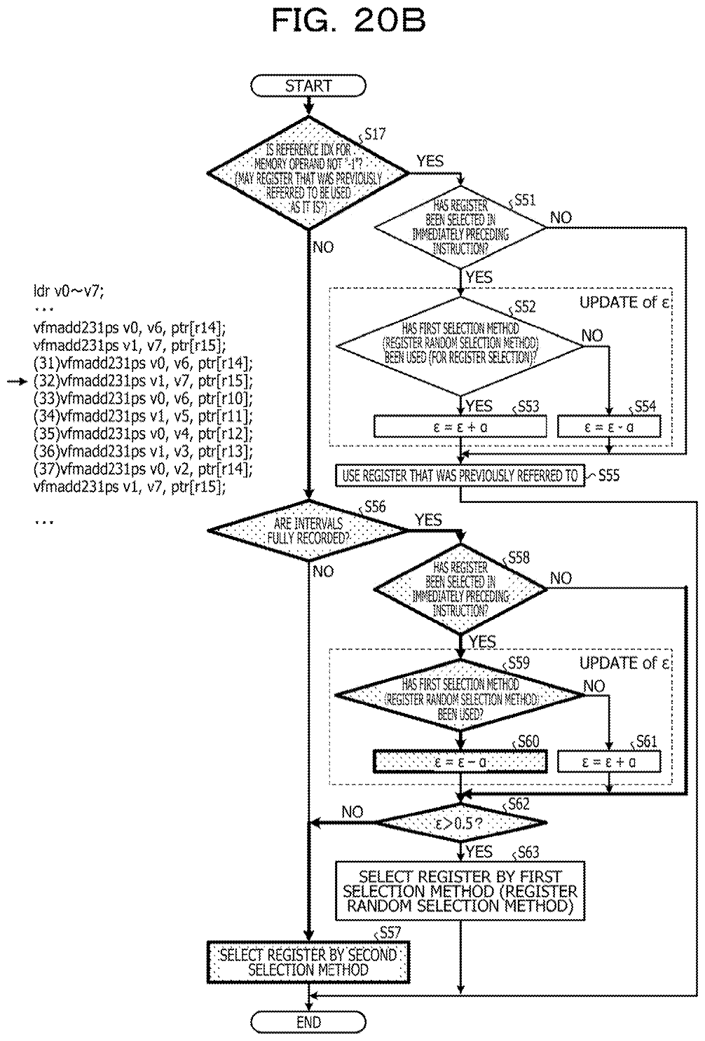

Another example of the register selection processing according to Embodiment 3 will be described with reference to FIGS. 20A and 20B. FIGS. 20A and 20B are diagrams illustrating another example of the register selection processing according to Embodiment 3. The group of CISC instructions is similar to the group of CISC instructions illustrated in FIG. 19A. The probability ε is 0.6.

FIG. 20A illustrates a case in which the CISC instruction (31) among the group of CISC instructions is converted. As a premise, in this case, the register that was previously referred to may not be used as it is. In this case, intervals are fully recorded. In this case, a register has not been selected in the immediately preceding instruction.

In the case of such a premise, since the register that was previously referred to may not be used as it is, the register selection unit 14B determines that the reference idx 22 for memory operand is “−1”. Since intervals are fully recorded, the probability control unit 30 determines whether a register has been selected in the immediately preceding instruction. Since a register has not been selected in the immediately preceding instruction, the register selection unit 14B determines whether the probability ε is larger than 0.5. Since the probability ε is 0.6, the register selection unit 14B selects a register by the first selection method. For example, register v7 is selected by the first selection method. After that, the equivalent instruction generation unit 18 uses v7 as a register into which memory operand ptr[r14] is loaded, and converts the CISC instruction (31) into a RISC instruction.

Next, FIG. 20B illustrates a case in which the CISC instruction (32) among the group of CISC instructions is converted. In this case, since register v7 that was previously referred to is designated in the CISC instruction (32), register v7 that was previously referred to may not be used as it is. In this case, intervals are fully recorded. In this case, a register has been selected in the immediately preceding instruction by the first selection method.

In such a case, since the register that was previously referred to may not be used as it is, the register selection unit 14B determines that the reference idx 22 for memory operand is “−1”. Since intervals are fully recorded, the probability control unit 30 determines whether a register has been selected in the immediately preceding instruction. It is determined that a register has been selected in the immediately preceding instruction. Additionally, since a register has been selected in the immediately preceding instruction by the first selection method, the probability control unit 30 decreases the probability ε by a. This is because it is presumed that a vector register has not been efficiently selected by the first selection method. It is assumed that the probability ε has decreased to 0.5. The register selection unit 14B determines whether the probability ε is larger than 0.5. Since the probability ε is 0.5, the register selection unit 14B selects a register by the second selection method. After that, the equivalent instruction generation unit 18 uses the register selected as a register into which memory operand ptr[r15] is loaded, and converts the CISC instruction (32) into a RISC instruction.

Also for the CISC instruction (33) and subsequent instructions, a register is selected based on the register selection processing according to Embodiment 3, and a CISC instruction is converted into a RISC instruction by using the selected register.

As described above, by updating the value of the probability ε of selecting the first selection method, the probability control unit 30 may suppress a case in which either one of the first selection method and the second selection method is continuously used. Even in a case in which although instructions designating vector registers in ascending order are generated in a group of CISC instructions, instructions designating vector registers in descending order are generated in the middle of the instructions, the register selection unit 14B may increase the efficiency of selecting a vector register for memory operand.

### Effect of Embodiment 3

According to the above Embodiment 3, when intervals associated with respective register numbers are fully set in the register management table 21A, the information processing apparatus 1 stochastically selects the first selection method or the second selection method, and selects a register number by the selected selection method. Accordingly, the information processing apparatus 1 may suppress a case in which either one of the first selection method and the second selection method is continuously used. Even in a case in which although instructions designating vector registers in ascending order are generated in a group of CISC instructions, instructions designating vector registers in descending order are generated in the middle of the instructions, the information processing apparatus 1 may increase the efficiency of selecting a vector register for memory operand.

[Others]

In the above Embodiments 1 to 3, the processing procedure, control procedure, specific names, and information including various types of data and parameters, which have been illustrated in the above documents and drawings, may be changed arbitrarily unless otherwise specified.

Each of the illustrated elements of each of the devices is a functional concept and does not have to be physically configured as illustrated. For example, specific forms of distribution and integration of each of the devices are not limited to those illustrated. For example, all or some of the devices may be configured to be functionally or physically distributed or integrated in an arbitrary unit(s) depending on various types of loads, usage conditions, and the like.

Entire portion or arbitrary portion of each of the processing functions performed in each of the devices may be implemented by a CPU and a program analyzed and executed by the CPU or by hardware using wired logic.

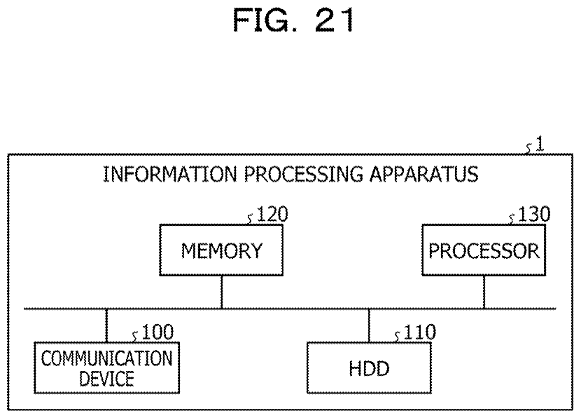

FIG. 21 is a diagram describing an example of a hardware configuration. As illustrated in FIG. 21, the information processing apparatus 1 includes a communication device 100, a hard disk drive (HDD) 110, a memory 120, and a processor 130. The components illustrated in FIG. 21 are coupled to one another by a bus or the like.

The communication device 100 is a network interface card or the like, and communicates with another apparatus. The HDD 110 stores a database (DB) and a program for operating the functions illustrated in FIGS. 1, 9, and 17.

The processor 130 operates a process of executing each function described in FIGS. 1, 9, and 17 by reading, from the HDD 110 or the like, a program that executes processing similar to that of each processing unit illustrated in FIGS. 1, 9, and 17 and loading the program in the memory 120. For example, this process executes a function similar to that of each processing unit included in the information processing apparatus 1. For example, the processor 130 reads, from the HDD 110 or the like, a program having a function similar to that of the control unit 10 or the like. The processor 130 executes a process of executing processing similar to that of the control unit 10 or the like.

As described above, the information processing apparatus 1 operates as an information processing apparatus that executes the conversion method by reading and executing a program. The information processing apparatus 1 may also implement functions similar to those of the embodiments described above by reading the above program from a recording medium with a medium reading device and executing the above read program. The program referred to in this other embodiment is not limited to being executed by the information processing apparatus 1. For example, the present disclosure may be similarly applied to a case where another computer or server executes the program or a case where the other computer and server execute the program in cooperation with each other.

This program may be distributed via a network such as the Internet. This program may be recorded on a computer-readable recording medium such as a hard disk, a flexible disk (FD), a compact disc read-only memory (CD-ROM), a magneto-optical (MO) disk, or a Digital Versatile Disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a conversion program for causing a computer to execute a process comprising:
incrementing a counter each time a complex instruction set computer (CISC) instruction is converted into a reduced instruction set computer (RISC) instruction;
when a CISC instruction with a memory operand is converted into a RISC instruction, updating conversion timing of a register used for conversion with a value of the counter;
recording a difference before and after update of conversion timing as an interval;
when a CISC instruction before conversion includes a use register number that stores a register number to be used for conversion of a memory operand, restoring data for a register indicated by the use register number, using a register management table in which a register number, conversion timing, and an interval are associated with each other and randomly selecting a register number from among register numbers that have a same interval condition, and updating the use register number with a selected register number;
saving data for a register indicated by the updated use register number, and using a register indicated by the updated use register number and generating an instruction for reading data of a memory operand;
when a CISC instruction before conversion does not include the use register number, using a register indicated by the use register number and generating an instruction for reading data of a memory operand without restoring and saving data for a register indicated by the use register number; and
generating the RISC instruction equivalent to the CISC instruction.

2. The non-transitory computer-readable recording medium according to claim 1,
wherein, in the updating of the use register number, when intervals associated with respective register numbers are fully set in the register management table, a register number is selected by a first selection method of excluding the use register number and randomly selecting a register number from among register numbers that have a same interval condition.

3. The non-transitory computer-readable recording medium according to claim 2,
wherein, in the updating of the use register number, when a plurality of intervals with different values is stored in the register management table, a register number is selected from among register numbers that have a larger value of interval.

4. The non-transitory computer-readable recording medium according to claim 2,
wherein, in the updating of the use register number, when intervals associated with respective register numbers are not fully set in the register management table, a register number is selected by a second selection method of selecting a register number of an oldest conversion timing that is different from the use register number.

5. The non-transitory computer-readable recording medium according to claim 4,
wherein, in the updating of the use register number, when intervals associated with respective register numbers are fully set in the register management table, the first selection method or the second selection method is stochastically selected and a register number is selected by a selected selection method.

6. A conversion method comprising:
incrementing a counter each time a complex instruction set computer (CISC) instruction is converted into a reduced instruction set computer (RISC) instruction;
when a CISC instruction with a memory operand is converted into a RISC instruction, updating conversion timing of a register used for conversion with a value of the counter;
recording a difference before and after update of conversion timing as an interval;
when a CISC instruction before conversion includes a use register number that stores a register number to be used for conversion of a memory operand, restoring data for a register indicated by the use register number, using a register management table in which a register number, conversion timing, and an interval are associated with each other and randomly selecting a register number from among register numbers that have a same interval condition, and updating the use register number with a selected register number;
saving data for a register indicated by the updated use register number, and using a register indicated by the updated use register number and generating an instruction for reading data of a memory operand;
when a CISC instruction before conversion does not include the use register number, using a register indicated by the use register number and generating an instruction for reading data of a memory operand without restoring and saving data for a register indicated by the use register number; and
generating the RISC instruction equivalent to the CISC instruction.
